(19) United States
(12) Patent Application Publication
(10) Pub. No.: US 2026/0101353 A1
(43) Pub. Date: Apr. 9, 2026

(54) METHOD, DEVICE AND COMPUTER STORAGE MEDIUM OF COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 19/114,908

(22) PCT Filed: Sep. 27, 2022
(86) PCT No.: PCT/CN2022/121830

§ 371 Date: Mar. 25, 2025

(51) Int. Cl. H04W 72/231; H04L 5/00; H04W 72/1273

(52) U.S. Cl. CPC H04W 72/231; H04L 5/0051; H04W 72/1273

(57) ABSTRACT

Example embodiments of the present disclosure relate to an effective mechanism for handing the scenario of discontinuous coverage. In this solution, a terminal device receives a demodulation reference signal (DMRS) indication indicating at least one of at least one DMRS port index or a first length of frequency domain orthogonal cover code (FD-OCC) to be used by the terminal device; and determining, based on the DMRS indication, the number of code domain multiplexing (CDM) groups without data is a default value if at least one of the following: the first length of FD-OCC is longer than a second FD-OCC length, at least one of the at least one DMRS port index is comprised in a first port index set, or at least one of the at least one DMRS port index corresponds to the first length of FD-OCC. In this way, in signalling overhead is reduced.

### TECHNICAL FIELD

Embodiments of the present disclosure generally relate to the field of telecommunication, and in particular, to methods, devices and computer storage media for configuration and transmission of demodulation reference signal (DMRS).

### BACKGROUND

Wireless communication networks are widely deployed and can support various types of service applications for terminal devices. Many communication schemes have been proposed to support the rapidly increasing data traffic. For example, in order to meet the increasing wireless data traffic demand, a plurality of schemes have been proposed and implemented, where a multiple input multiple output (MIMO) technology is considered as one powerful scheme to achieve high data throughputs in the communication system. MIMO refers to the type of wireless transmission and reception scheme where both a transmitter and a receiver employ more than one antenna. In particular, MIMO includes features that facilitate utilization of a large number of antenna elements at base station for both sub-6 GHz and over-6 GHz frequency bands.

Generally speaking, a reference signal (RS) transmission is necessary for the wireless communication. Further, an RS that is used for demodulation of data or control signals is referred to as a demodulation (DM) RS. In the following 3rd-generation partnership project (3GPP) release 18, some DMRS enhancements are expected to be achieved, such as, the number of orthogonal ports for DMRS is agreed to be increased. However, due to the increased number of orthogonal ports for DMRS, the length of frequency domain orthogonal cover code (FD-OCC) may be longer, which causes that the signalling overhead is increased accordingly, and also cases the FD-OCC mapping inconsistent among the UEs.

### SUMMARY

In general, embodiments of the present disclosure provide methods, devices and computer storage media for configuration and transmission of DMRS.

In a first aspect, there is provided a method of communication. The method comprises: receiving, at a terminal device and from a network device, a DMRS indication indicating at least one of at least one DMRS port index or a first length of FD-OCC to be used by the terminal device. The method further comprises determining, based on the indication, the number of CDM groups without data is a default value if at least one of the following: the first length of FD-OCC is longer than a second FD-OCC length, at least one of the at least one DMRS port index is comprised in a first port index set, or at least one of the at least one DMRS port index corresponds to the first length of FD-OCC.

In a second aspect, there is provided a method of communication. The method comprises: obtaining, the number of CDM groups without data configured for a terminal device enabling to communicate with a network device via a FD-OCC with a first length, wherein the first length is longer than a second FD-OCC length. The method further comprises performing a DMRS communication via a first power ratio of a PDSCH to the DMRS, wherein the first power ratio is larger than a second power ratio, and the second power ratio is based on the number of CDM groups without data.

In a third aspect, there is provided a method of communication. The method comprises: obtaining, a configuration for a DMRS transmission with a first DMRS. The method further comprises in case of a length of FD-OCC associated with the DMRS transmission is 4, performing, based on the configuration, an FD-OCC mapping on at least one resource block (RB) based on at least one of the following: a common RB index, a precoding group boundary, a physical resource block (PRB) bundling boundary, or a common RB bundling boundary.

In a fourth aspect, there is provided a terminal device. The terminal device includes a processing unit; and a memory coupled to the processing unit and storing instructions thereon, the instructions, when executed by the processing unit, causing the device to perform the method according to the first aspect.

In a fifth aspect, there is provided a device. The device includes a processing unit; and a memory coupled to the processing unit and storing instructions thereon, the instructions, when executed by the processing unit, causing the device to perform the method according to the second aspect.

In a sixth aspect, there is provided a device. The device includes a processing unit; and a memory coupled to the processing unit and storing instructions thereon, the instructions, when executed by the processing unit, causing the device to perform the method according to the third aspect.

In a seventh aspect, there is provided a computer readable medium having instructions stored thereon, the instructions, when executed on at least one processor, causing the at least one processor to carry out the method according to the first to any of the third aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates a port mapping of DMRS type 1 according to 3GPP release 15;

FIG. 1B illustrates a port mapping of DMRS type 2 according to 3GPP release 15;

FIG. 2 is a block diagrams of an example communication environment in which embodiments of the present disclosure can be implemented;

FIG. 3A illustrates a port mapping of DMRS type 1 according to some embodiments of the present disclosure;

FIG. 3B illustrates a port mapping of DMRS type 2 according to some embodiments of the present disclosure;

FIG. 4 illustrates a signaling chart illustrating a process for communication according to some embodiments of the present disclosure;

FIG. 5A illustrates an example of FD-OCC mapping according to some embodiments of the present disclosure;

FIG. 5B illustrates another example of FD-OCC mapping according to some embodiments of the present disclosure;

FIG. 6 illustrates an example method of communication implemented at a terminal device in accordance with some embodiments of the present disclosure;

FIG. 7 illustrates an example method of communication implemented at a device in accordance with some embodiments of the present disclosure;

FIG. 8 illustrates an example method of communication implemented at a device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further have ‘multicast/broadcast’ feature, to support public safety and mission critical, V2X applications, transparent IPv4/Ipv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As discussed above, the RS transmission is necessary for the wireless communication. Further, DMRS is used for both uplink and downlink demodulation. In 3GPP release 15, it has been agreed that two types of DMRS (i.e., DMRS type 1 and DMRS type 2) should be supported.

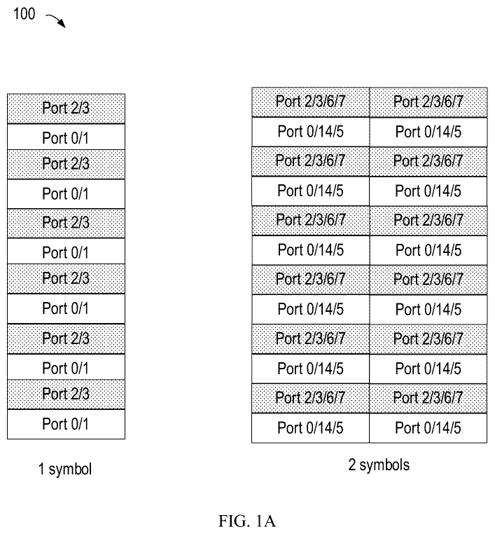

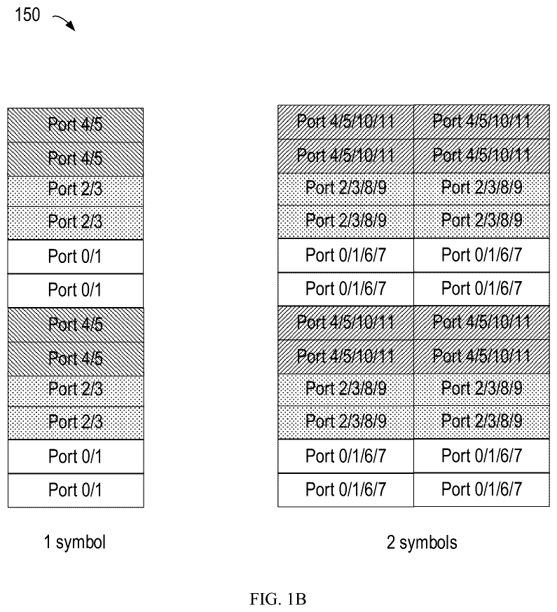

Reference is made to FIG. 1A, which illustrates a port mapping 100 of DMRS type 1 according to 3GPP release 15. As can be seen from FIG. 1A, the DMRS ports may be mapped to either 1 symbol (also referred to as a signal-symbol DMRS type 1) or 2 symbols (also referred to as a double-symbol DMRS type 1). Further, ports set {0, 1, 2, 3} are configured for the signal-symbol DMRS type 1, and ports set {0, 1, 2, 3, 4, 5, 6, 7} are configured for the double-symbol DMRS type 1.

Reference is made to FIG. 1B, which illustrates a port mapping 150 of DMRS type 2 according to 3GPP release 15. As can be seen from FIG. 1B, similar with DMRS type 1, the DMRS ports also may be mapped to either 1 symbol (also referred to as a signal-symbol DMRS type 2) or 2 symbols (also referred to as a double-symbol DMRS type 2). Further, ports set {0, 1, 2, 3, 4, 5} are configured for signal-symbol DMRS type 1, and ports set {0, 1, 2, 3, 4, 5, 6, 7, 8, 9, 10, 11} are configured for double-symbol DMRS type 2.

As discussed above, some DMRS enhancements are expected to be achieved, such as, the number of orthogonal ports for DMRS is agreed to be increased. In some embodiments, it is expected to specify larger number of orthogonal DMRS ports for downlink and uplink, multi-user multiple-input multiple-output (MU-MIMO) (without increasing the DMRS overhead), only for cyclic prefix orthogonal frequency division multiplexing (CP-OFDM). Further, in some embodiments, a common design between downlink and uplink DMRS and up to 24 orthogonal DM-RS ports (where for each applicable DMRS type, the maximum number of orthogonal ports is doubled for both single-symbol and double-symbol DMRS) are strived.

Further, in 3GPP release 15, the length of FD-OCC is 2. In some embodiments, in order to increase the number of DMRS ports for physical downlink shared channel (PDSCH)/physical uplink shared channel (PUSCH), the length of FD-OCC may be larger than 2, such as, 4 or 6, referred to as enhanced FD-OCC length sometimes. Specifically, in some embodiments, for enhanced FD-OCC length for DMRS of PDSCH/PUSCH, support the following FD-OCC length:
For DMRS type 1, down select from the following:
Option 1: length 6 FD-OCC is applied to 6 resource elements (REs) of DMRS within a physical resource block (PRB) within a code domain multiplexing (CDM) group;
Option 2: length 4 FD-OCC is applied to 4 REs of DMRS within a PRB or across consecutive PRBs within a CDM group;
For DMRS type 2:
Option 1: length 4 FD-OCC is applied to 4 REs of DMRS within a PRB within a CDM group;
Option 2: length 6 FD-OCC may be/may be not supported.

In some embodiments, MU-MIMO is supported between 3GPP release 15 DMRS ports and 3GPP release 18 DMRS ports, and also supported between 3GPP release 15 UEs and 3GPP release 18 UEs.

In some embodiments, in order to support of more than 4 layers single user (SU)-MIMO PUSCH, the following potential enhancements for PTRS-DMRS association may be studied: whether to support more than 2-port uplink, and whether to increase the DCI size of phase-tracking reference signals (PTRS)-DMRS association field in DCI format 0_1/0_2.

In some embodiments, as for increased DMRS ports for enhanced FD-OCC, DCI based switching between DMRS port(s) associated with length 2 FD-OCC and DMRS port(s) associated with length M FD-OCC (where M>2) is supported.

In some embodiments, as for PUSCH with layer larger than 4, rank=5, 6, 7, 8 is supported for both DMRS type 1 and type 2 and supported for both single-symbol DMRS and double-symbol DMRS.

In some embodiments, for downlink DMRS associated with PDSCH, the UE may assume the ratio of PDSCH energy per resource element (EPRE) to DMRS EPRE (β_{DMRS} [dB]) is given by below Table A according to the number of DMRS CDM groups without data. The DMRS scaling factor

$${β}_{PDSCH}^{DMRS}$$

is given by

$${β}_{PDSCH}^{DMRS} = {10}^{- \frac{{β}_{DMRS}}{20}} .$$

TABLE A
The ratio of PDSCH EPRE to DMRS EPRE

| Number of DMRS CDM | | |
|---|---|---|
| groups without data | DMRS type 1 | DMRS type 2 |
| 1 | 0 dB | 0 dB |
| 2 | −3 dB | −3 dB |
| 3 | — | −4.77 dB |

In some embodiments, for uplink DMRS associated with PUSCH, the UE may assume the ratio of PUSCH EPRE to DMRS EPRE (β_{DMRS} [dB]) is given by below Table B according to the number of DMRS CDM groups without data. The DMRS scaling factor

$${β}_{PDSCH}^{DMRS}$$

is given by

$${β}_{PUSCH}^{DMRS} = {10}^{- \frac{{β}_{DMRS}}{20}} .$$

TABLE B
The ratio of PUSCH EPRE to DMRS EPRE

| Number of DMRS CDM | | |
|---|---|---|
| groups without data | DMRS type 1 | DMRS type 2 |
| 1 | 0 dB | 0 dB |
| 2 | −3 dB | −3 dB |
| 3 | — | −4.77 dB |

Through the above discussions, it may be concluded that the number of orthogonal ports for DMRS and the length of FD-OCC would be increased. However, due to the increased number of orthogonal ports for DMRS and the enhanced length of FD-OCC, the signalling overhead and the inter-UE interference are also increased. Further, due the enhanced length of FD-OCC, the FD-OCC mapping may need two RBs to achieve orthogonalization. However, the RBs are indexed by different UEs separately, which causes that the FD-OCC mapping among the UEs are not consistently and the inter-UE interference are increased thereby.

In view of this, in case that more DMRS ports and longer length of FD-OCC are introduced, how to indicate the DMRS configuration without introducing too much signalling overhead, how to determine the DMRS transmit power, and how to map the FD-OCC are needed to be further discussed.

According to some embodiments of the present discourse, at least part of the above pending issues will be addressed.

Embodiments of the present disclosure provide a solution for configuration and transmission of DMRS. In the present disclosure, a terminal device receives a DMRS indication from the network device, where the DMRS indication indicates at least one of the following: at least one DMRS port index or a first length of FD-OCC (such as, 4 or 6) to be used by the terminal device. The terminal device determines the number of CDM groups without data based on the indication. Specifically, if the first length of FD-OCC (such as, 4 or 6) is longer than a second FD-OCC length (such as, 2), at least one of the at least one DMRS port index is comprised in a first port index set (such as, {8, 9, 10, 11} or {8, 9, 10, 11, 12, 13, 14, 15} for DMRS type 1, or {12, 13, 14, 15, 16, 17} or {12, 13, 14, 15, 16, 17, 18, 19, 20, 21, 22, 23} for DMRS type 2), or at least one of the at least one DMRS port index corresponds to the first length of FD-OCC, the number of CDM groups without data is assumed/determined to be a default value. That is, impossible DMRS parameters combinations are excluded, and thus the bit length of the DMRS indication is shorted, Therefore, the signalling overhead is reduced thereby.

For ease of discussion, some terms used in the following description are listed as below:
a first length of FD-OCC: refers to a relative longer length of FD-OCC. In some embodiments, the first length of FD-OCC refers to a length of FD-OCC supported in 3GPP release 18. In some embodiments, the first length of FD-OCC may be 4 or 6.
a second length of FD-OCC: refers to a relative shorter length of FD-OCC. In some embodiments, the second length of FD-OCC refers to a length of FD-OCC supported in such as 3GPP release 15. In some embodiments, the second length of FD-OCC may be 2.
a first port index set: refers to a port index set comprising newly-introduced port indexes by 3GPP release 18. In some embodiments, the first port index set is one of the {8, 9, 10, 11} (such as, for single-symbol DMRS type 1), {8, 9, 10, 11, 12, 13, 14, 15} (such as, for double-symbol DMRS type 1), {12, 13, 14, 15, 16, 17} (such as, for single-symbol DMRS type 2) or {12, 13, 14, 15, 16, 17, 18, 19, 20, 21, 22, 23} (such as, for double-symbol DMRS type 2).

In the present discourse, terms of a first DMRS type, DMRS configuration type 1 and DMRS type 1 may be used interchangeably; terms of a second DMRS type, DMRS configuration type 2 and DMRS type 2 may be used interchangeably; terms of 2-symbol DMRS and double-symbol DMRS may be used interchangeably; and terms of 1-symbol DMRS and single-symbol DMRS may be used interchangeably.

Principles and implementations of the present disclosure will be described in detail below with reference to the figures.

### Example of Communication Network

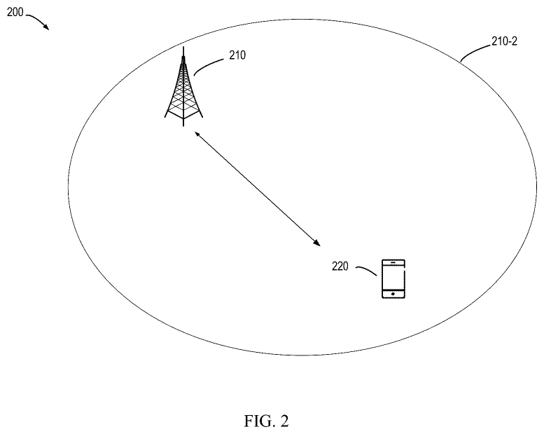

FIG. 2 shows an example communication environment 200 in which example embodiments of the present disclosure can be implemented. The communication environment 200 comprises a terminal device 220 and a network device 210. As shown in the FIG. 2, the network device 210 provides a serving area, called as a cell 210-2.

In the environment 200, a link from the network device 210 to the terminal device 220 is referred to as a downlink, while a link from the terminal device 220 to the network device 210 is referred to as an uplink. In downlink, the network device is a transmitting (TX) device (or a transmitter) and the terminal device 220 is a receiving (RX) device (or a receiver). In uplink, the terminal device 220 is a transmitting TX device (or a transmitter) and the network device is a RX device (or a receiver).

In some embodiments, both a downlink DMRS transmission and an uplink DMRS transmission are transmitted in the communication environment 200.

Further, in some embodiments, the downlink DMRS transmission and/or the uplink DMRS transmission may be configured/indicated by the network device 210. As one specifical embodiment, the network device 210 may transmit a downlink control information (DCI) message to the terminal device 220, where the DCI message may comprise a DMRS indication, the DMRS indication indicating at least one of the following: the DMRS port(s), the length of FD-OCC, the number of CDM group without data.

Further, in one specific embodiment, a table may be pre-configured at the network device 210 and the terminal device 220. Each item in the table refers to a DMRS parameter combination (including the DMRS port(s), the length of FD-OCC, the number of CDM groups without data) and indexed with a number value. The network device 210 may use the DMRS indication to indicate the number value, such that the DMRS parameter combination is indicated to the terminal device.

In some embodiments, both a first DMRS type (such as, DMRS type 1) and a second DMRS type (such as, DMRS type 2) are supported in the communication environment 200.

In some embodiments, both a 1-symble DMRS and a 2-symble DMRS are supported in the communication environment 200.

In some embodiments, the terminal device 220 (such as, 3GPP release 15 UE) enables to communicate with the network device 210 via FD-OCC with a relative shorter length (i.e., a second length of FD-OCC). Additionally, the DMRS port index set corresponding to the second length of FD-OCC may be one of the following:
For 1-symbol DMRS with a first DMRS type: {0, 1, 2, 3};
For 2-symbol DMRS with a first DMRS type: {0, 1, 2, 3, 4, 5, 6, 7};
For 1-symbol DMRS with a second DMRS type: {0, 1, 2, 3, 4, 5}; or
For 2-symbol DMRS with a second DMRS type: {0, 1, 2, 3, 4, 5, 6, 7, 8, 9, 10, 11}.

In some embodiments, the terminal device 220 (such as, 3GPP release 18 UE) enables to communicate with the network device 210 via FD-OCC with relative longer length (i.e., a first length of FD-OCC). Additionally, the DMRS port index set corresponding to the first length of FD-OCC may be one of the following:
For 1-symbol DMRS with a first DMRS type: {0, 1, 2, 3, 8, 9, 10, 11};
For 2-symbol DMRS with a first DMRS type: {0, 1, 2, 3, 4, 5, 6, 7, 8, 9, 10, 11, 12, 13, 14, 15};
For 1-symbol DMRS with a second DMRS type: {0, 1, 2, 3, 4, 5, 12, 13, 14, 15, 16, 17}; or
For 2-symbol DMRS with a second DMRS type: {0, 1, 2, 3, 4, 5, 6, 7, 8, 9, 10, 11, 12, 13, 14, 15, 16, 17, 18, 19, 20, 21, 22, 23}.

It can be seen that, compared with the DMRS port index set corresponding to the second length of FD-OCC, the DMRS port index set corresponding to the first length of FD-OCC may comprises an incremental port index set, which may be called as the first port index set. In some embodiments, the first port index set is defined as below:
For 1-symbol DMRS with a first DMRS type: {8, 9, 10, 11};
For 2-symbol DMRS with a first DMRS type: {8, 9, 10, 11, 12, 13, 14, 15};
For 1-symbol DMRS with a second DMRS type: {12, 13, 14, 15, 16, 17}; or
For 2-symbol DMRS with a second DMRS type: {12, 13, 14, 15, 16, 17, 18, 19, 20, 21, 22, 23}.

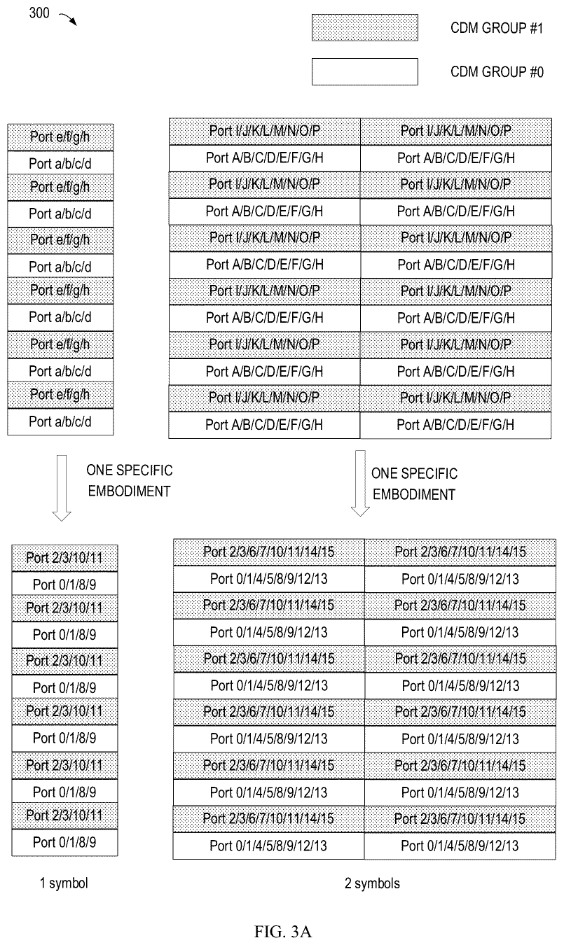

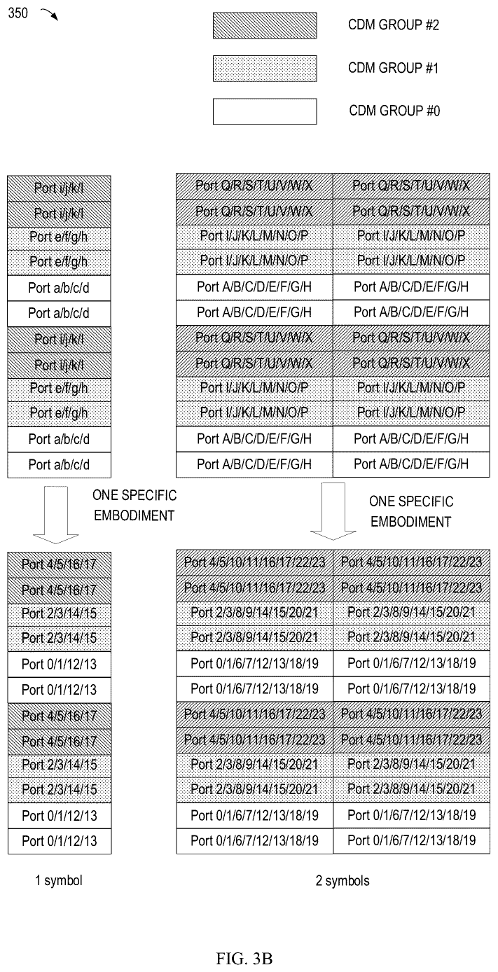

Reference is made to FIGS. 3A and 3B, where FIG. 3A illustrates a port mapping 300 of DMRS with a first DMRS type, and FIG. 3B illustrates a port mapping 350 with a second DMRS type.

Some specific embodiments of port mappings are discussed as below. In some embodiments, as shown in FIG. 3A, in case of 1-symbol DMRS with a first DMRS type,
Ports {0, 1, 8, 9} are mapped on same time/frequency domain resources (Res) and multiplexed with length-4 or length-6 FD-OCC, and
Ports {2, 3, 10, 11} are mapped on same time/frequency domain resources (Res) and multiplexed with length-4 or length-6 FD-OCC.

In some embodiments, in case of 2-symbol DMRS with a first DMRS type,
Ports {0, 1, 8, 9} are mapped on same time/frequency domain resources (Res), multiplexed with length-4 or length-6 FD-OCC.
Ports {2, 3, 10, 11} are mapped on same time/frequency domain resources (Res), multiplexed with length-4 or length-6 FD-OCC.
Ports {4, 5, 12, 13} are mapped on same time/frequency domain resources (Res), multiplexed with length-4 or length-6 FD-OCC.
Ports {6, 7, 14, 15} are mapped on same time/frequency domain resources (Res), multiplexed with length-4 or length-6 FD-OCC.

In some embodiments, as shown in FIG. 3A, in case of 2-symbol DMRS with a first DMRS type, ports {0, 4} or {1, 5} or {2, 6} or {3, 7} or {8, 12} or {9, 13} or {10, 14} or {11, 15} are mapped on same time/frequency domain resources (Res), and multiplexed with length-2 time domain orthogonal cover code (TD-OCC).

In some embodiments, in case of 2-symbol DMRS with a first DMRS type, ports {0, 1, 4, 5, 8, 9, 12, 13} and ports {2, 3, 6, 7, 10, 11, 14, 15} are mapped on different Res, and multiplexed with frequency domain multiplexing (FDM).

In the specific embodiments of FIG. 3A, port set {8, 9, 10, 11, 12, 13, 14, 15} is used as example port set, which may be represented as {I, J, K, L, M, N, O, P}, where each of ports {I, J, K, L, M, N, O, P} may be any one of {8, 9, 10, 11, 12, 13, 14, 15}, and different from each other.

In some embodiments, as shown in FIG. 3B, in case of 1-symbol DMRS with a second DMRS type,
Ports {0, 1, 12, 13} are mapped on same time/frequency domain resources (Res), multiplexed with length-4 or length-6 FD-OCC.
Ports {2, 3, 14, 15} are mapped on same time/frequency domain resources (Res), multiplexed with length-4 or length-6 FD-OCC.
Ports {4, 5, 16, 17} are mapped on same time/frequency domain resources (Res), multiplexed with length-4 or length-6 FD-OCC.

In some embodiments, in case of 2-symbol DMRS with a second DMRS type,
Ports {0, 1, 12, 13} are mapped on same time/frequency domain resources (Res), multiplexed with length-4 or length-6 FD-OCC.
Ports {2, 3, 14, 15} are mapped on same time/frequency domain resources (Res), multiplexed with length-4 or length-6 FD-OCC.
Ports {4, 5, 16, 17} are mapped on same time/frequency domain resources (Res), multiplexed with length-4 or length-6 FD-OCC.
Ports {6, 7, 18, 19} are mapped on same time/frequency domain resources (Res), multiplexed with length-4 or length-6 FD-OCC.
Ports {8, 9, 20, 21} are mapped on same time/frequency domain resources (Res), multiplexed with length-4 or length-6 FD-OCC.
Ports {10, 11, 22, 23} are mapped on same time/frequency domain resources (Res), multiplexed with length-4 or length-6 FD-OCC.

In some embodiments, in case of 2-symbol DMRS with a second DMRS type, ports {0, 6} or {1, 7} or {2, 8} or {3, 9} or {4, 10} or {5, 11} or {12, 18} or {13, 19} or {14, 20} or {15, 21} or {16, 22} or {17, 23} are mapped on same time/frequency domain resources (Res), multiplexed with length-2 TD-OCC.

In some embodiments, as shown in FIG. 3B, in case of 2-symbol DMRS with a second DMRS type, ports {0, 1, 6, 7, 12, 13, 18, 19} and Ports {2, 3, 8, 9, 14, 15, 20, 21} and ports {4, 5, 10, 11, 16, 17, 22, 23} are mapped on different Res, multiplexed with FDM.

In the specific embodiments of FIG. 3B, port set {12, 13, 14, 15, 16, 17, 18, 19, 20, 21, 22, 23} is used as example port set, which may be represented as {I, J, K, L, M, N, O, P, Q, S, R, T, U, V, W, X}, where each of ports {I, J, K, L, M, N, O, P, Q, S, R, T, U, V, W, X} may be any one of {12, 13, 14, 15, 16, 17, 18, 19, 20, 21, 22, 23}, and different from each other.

In some embodiments, the terminal device 220 and the network device 210 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 200 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

### Example Processes

It should be understood that although feature(s)/operation(s) are discussed in specific example embodiments separately, unless clearly indicated to the contrary, these feature(s)/operation(s) described in different example embodiments may be used in any suitable combination.

Further, it is to be understood that the operations at the terminal device 220 and the network device 210 should be coordinated. In other words, the network device 210 and the terminal device 220 should have common understanding about configuration, parameters and so on. Such common understanding may be implemented by any suitable interactions between the network device 210 and the terminal device 220 or both the network device 210 and the terminal device 220 applying the same rule/policy. In the following, although some operations are described from a perspective of the terminal device 220, it is to be understood that the corresponding operations should be performed by the network device 210. Similarly, although some operations are described from a perspective of the network device 210, it is to be understood that the corresponding operations should be performed by the terminal device 220. Merely for brevity, some of the same or similar contents are omitted here.

In addition, in the following description, some interactions are performed among the terminal device 220 and the network device 210. It is to be understood that the interactions may be implemented either in one single signaling/message or multiple signaling/messages, including system information (SI), RRC message, downlink control information (DCI) message, uplink control information (UCI) message, media access control (MAC) control element (CE) and so on. The present disclosure is not limited in this regard.

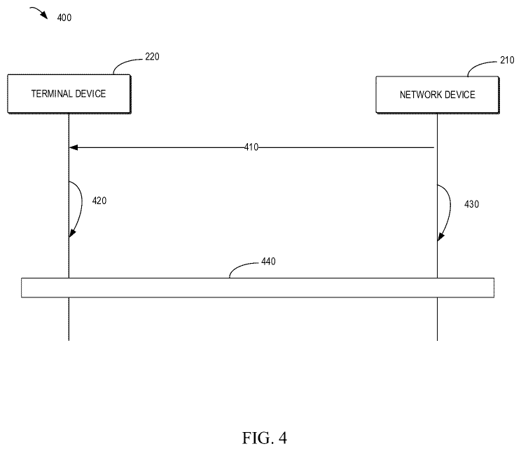

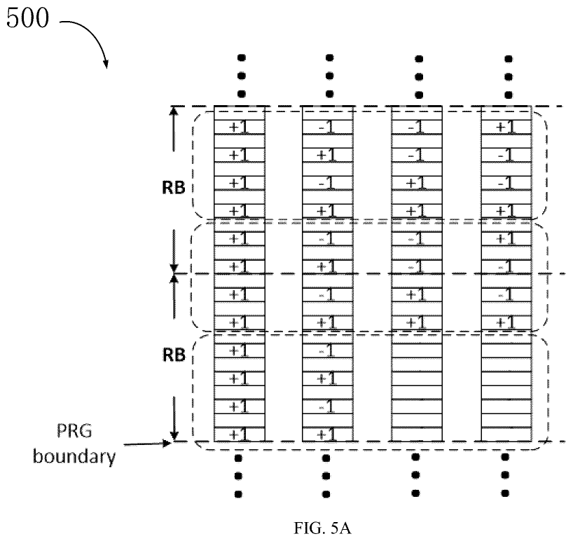

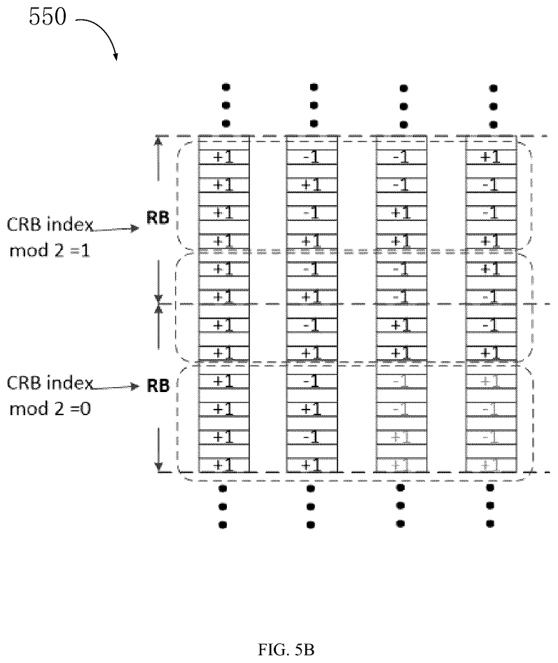

Principle and implementations of the present disclosure will be described in detail below with reference to FIGS. 4, 5A and 5B. For the purpose of discussion, FIGS. 4, 5A and 5B will be described with reference to FIGS. 2, 3A and 3B.

### Example Processed for DMRS Configuration

In some embodiments, switching between FD-OCC with a second length (such as, 2) and FD-OCC with a first length (such as, 4 or 6) is supported by a DMRS indication.

In some embodiments, DMRS ports (with length-4 or length-6 FD-OCC) are indicated only in case of the DMRS ports (with length-2 FD-OCC) have been all allocated. That is, the first port index set (as discussed above) may be indicated only in case of the DMRS port index set corresponding to the second length of FD-OCC have been allocated.

In view of this, there is no need of indication of FD-OCC 4/6 (i.e., new DMRS ports) if one of the following:
the total number of DMRS ports (SU or MU) is less than or equal to 4 or 6 in case of 1-symbol DMRS with a first DMRS type;
the total number of DMRS ports (SU or MU) is less than or equal to 8 or 12 in case of 2-symbol DMRS with a first DMRS type;
the total number of DMRS ports (SU or MU) is less than or equal to 6 or 8 in case of 1-symbol DMRS with a second DMRS type;
the total number of DMRS ports (SU or MU) is less than or equal to 12 or 16 in case of 2-symbol DMRS with a second DMRS type.

In some embodiments, the DMRS ports (with length-4 or length-6 FD-OCC) are indicated means that the number of CDM groups without data is 2 for the first DMRS type. In some embodiments, the DMRS ports (with length-4 or length-6 FD-OCC) are indicated means that the number of CDM groups without data is 3 for the second DMRS type.

For example, as for 1-symbol DMRS with a first DMRS type, if any of DMRS ports {8, 9, 10, 11} is indicated, it means that the ports {0, 1, 2, 3} have been allocated, and thus the number of CDM groups without data should be 2 accordingly.

In view of this, the signaling overhead may be reduced by excluding the impossible DMRS parameters combinations, such as, any of ports {8, 9, 10, 11} and the number of CDM groups without data is 1 for single-symbol DMRS type 1.

Reference is now made to FIG. 4, which shows a signaling chart illustrating a process 400 of communication according to some example embodiments of the present disclosure. For the purpose of discussion, the process 400 will be described with reference to FIG. 2. The process 400 may involve the terminal device 220 and the network device 210.

In some embodiments, the terminal device 220 receives 410 a DMRS indication from the network device 210, where the DMRS indication indicates at least one of at least one DMRS port index or a first length of FD-OCC to be used by the terminal device 220. Then, based on the DMRS indication the terminal device 220 determines 420 the number of CDM groups without data to be a default value if at least one of the following:
the first length of FD-OCC is longer than a second FD-OCC length,
at least one of the at least one DMRS port index is comprised in a first port index set, or
at least one of the at least one DMRS port index corresponds to the first length of FD-OCC.

In some embodiments, the DMRS indication is comprised in DCI message.

In some embodiments, in case of a first DMRS type, the default value is 2. In some embodiments, in case of a second DMRS type, the default value is 3.

In some embodiments, the second FD-OCC length is 2, and the first length of FD-OCC is 4 or 6.

In some embodiments, in case of a first DMRS type, the first port index set is one of {8, 9, 10, 11} or {8, 9, 10, 11, 12, 13, 14, 15}.

In some embodiments, in case of a second DMRS type, the first port index set is one of {12, 13, 14, 15, 16, 17} or {12, 13, 14, 15, 16, 17, 18, 19, 20, 21, 22, 23}.

For better understanding, some specific embodiments are discussed as below. In one specific embodiment of DMRS type 1, the first port index set is {8, 9, 10, 11} and/or {8, 9, 10, 11, 12, 13, 14, 15}. If the port(s) in the first port index set are indicated by the DMRS indication, it implies that all the ports comprised in ports set {0, 1, 2, 3} and/or {0, 1, 2, 3, 4, 5, 6, 7} have been allocated, i.e., the number of CDM groups without data should be 2.

In one embodiment of DMRS type 2, the first port index set is {12, 13, 14, 15, 16, 17} and/or {12, 13, 14, 15, 16, 17, 18, 19, 20, 21, 22, 23}. If the port(s) in the first port index set are indicated, it implies that all the ports comprised in ports set {0, 1, 2, 3, 4, 5} and/or {0, 1, 2, 3, 4, 5, 6, 7, 8, 9, 10, 11} have been allocated, i.e., the number of CDM groups without data should be 3.

In some embodiments, there are duplicated indications with same number of DMRS port(s) and same index(es) of DMRS port(s) and/or same number of CDM groups without data to indicate different length of FD-OCC.

As discussed above, one or more tables may be pre-configured at the network device 210 and the terminal device 220. Each item in the table(s) refers to a DMRS parameter combination (including the DMRS port(s), the length of FD-OCC, the number of CDM groups without data) and indexed with a number value. The network device 210 may use the DMRS indication to indicate the number value, such that the DMRS parameter combination is indicated. By using the pre-configured table and the DMRS indication discussed above, the network device 210 and the terminal device 220 may configure/obtain the DMRS parameters/configuration.

Below are some examples of the pre-configured table(s). It should be understood that in some embodiments, the items comprised in a same table may be divided into a plurality of tables. In other words, the items comprised in any of the below tables may be combined in any manner. The present discourse is not limited in this regard. In some embodiments, a subset of columns and/or a subset of rows of at least one of the pre-configured table(s) may be applied for DMRS indication. For example, the columns of the below example tables refer to different parameters. In the other embodiments, the number of columns may be lesser, i.e., a subset of columns. Alternatively, or in addition, the rows of the below example tables refer to correspondences. In the other embodiments, the number of rows may be lesser, i.e., a subset of rows.

That is, the below example tables actually indicate correspondences among different parameters. In some other embodiments, other tables may be used for indicating any combination of the correspondences indicated in the below example tables.

Moreover, the numbers/indexes in the column of ‘value are only for the purpose of illustration without suggesting any limitations. In the other words, the numbers/indexes in the column of ‘value may be changed according to the size of the respective table and the item order in the respective table.

Below table 1 illustrates an example of downlink DMRS table, where the length of FD=OCC is M and M is 4 or 6.

TABLE 1
Antenna port(s) (1000 + DMRS port), dmrs-Type = 1, maxLength = 1

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | | | DMRS CDM | | |
| | group(s) | | | | group(s) | | |
| | without | DMRS | FD-OCC | | without | DMRS | FD-OCC |
| Value | data | port(s) | length | Value | data | port(s) | length |
| 0 | 1 | 0 | 2 | 0 | 2 | 0, 1, 2, 3, 8 | M |
| 1 | 1 | 1 | 2 | 1 | 2 | 0, 1, 2, 3, 8, 10 | M |
| 2 | 1 | 0, 1 | 2 | 2 | 2 | 0, 1, 2, 3, 8, 9, 10 | M |
| 3 | 2 | 0 | 2 | 3 | 2 | 0, 1, 2, 3, 8, 9, 10, 11 | M |
| 4 | 2 | 1 | 2 | 4-31 | reserved | reserved | reserved |
| 5 | 2 | 2 | 2 | | | | |
| 6 | 2 | 3 | 2 | | | | |
| 7 | 2 | 0, 1 | 2 | | | | |
| 8 | 2 | 2, 3 | 2 | | | | |
| 9 | 2 | 0-2 | 2 | | | | |
| 10 | 2 | 0-3 | 2 | | | | |
| 11 | 2 | 0, 2 | 2 | | | | |
| 12 | 2 | 0, 2, 3 | 2 | | | | |
| 13 | 2 | 0 | M | | | | |
| 14 | 2 | 1 | M | | | | |
| 15 | 2 | 2 | M | | | | |
| 16 | 2 | 3 | M | | | | |
| 17 | 2 | 8 | M | | | | |
| 18 | 2 | 9 | M | | | | |
| 19 | 2 | 10 | M | | | | |
| 20 | 2 | 11 | M | | | | |
| 21 | 2 | 0, 1 | M | | | | |
| 22 | 2 | 2, 3 | M | | | | |
| 23 | 2 | 8, 9 | M | | | | |
| 24 | 2 | 10, 11 | M | | | | |
| 25 | 2 | 0, 1, 8 | M | | | | |
| 26 | 2 | 2, 3, 10 | M | | | | |
| 27 | 2 | 0, 1, 8, 9 | M | | | | |
| 28 | 2 | 2, 3, 10, 11 | M | | | | |
| 29 | 2 | 0, 1, 2 | M | | | | |
| 30 | 2 | 8, 9, 10 or | M | | | | |
| | | 8, 10, 11 | | | | | |
| 31 | 2 | 0, 2, 3 | M | | | | |
| 32 | 2 | 0, 1, 2, 3 | M | | | | |
| 33 | 2 | 8, 9, 10, 11 | M | | | | |

In the above table 1, item 12 my be used for the scenario of multi-TRP. For example, 2 or 3 or 4 transmission configuration indication (TCI) states are indicated and the indicated DMRS ports are comprised in two CDM groups. In some embodiments, the item 12 may not be comprised in the table 1. In one example embodiment, only one TCI state is indicated. In another example embodiment, the indicated DMRS port(s) is comprised in one CDM group.

In the above table 1, items 29 to 33 may be used for the scenario of multi-TRP and MU. For example, 2 or 3 or 4 TCI states are indicated and the indicated DMRS ports are comprised in two CDM groups. In some embodiments, the items 29 to 33 may not be comprised in the table 1. In one example embodiment, only one TCI state is indicated. In another example embodiment, the indicated DMRS port(s) is comprised in one CDM group.

Below table 2 illustrates another example of downlink DMRS table, where the length of FD=OCC is M and M is 4 or 6.

TABLE 2
Antenna port(s) (1000 + DMRS port), dmrs-Type = 1, maxLength = 2

| One Codeword: | | | | | Two Codewords: | | | | |
|---|---|---|---|---|---|---|---|---|---|
| Codeword 0 enabled, | | | | | Codeword 0 enabled, | | | | |
| Codeword 1 disabled | | | | | Codeword 1 enabled | | | | |
| | Number of | | | | | Number of | | | |
| | DMRS CDM | | | | | DMRS CDM | | | |
| | group(s) | | Number of | | | group(s) | | Number of | |
| | without | DMRS | front-load | FD-OCC | | without | DMRS | front-load | FD-OCC |
| Value | data | port(s) | symbols | length | Value | data | port(s) | symbols | length |
| 0 | 1 | 0 | 1 | 2 | 0 | 2 | 0-4 | 2 | 2 |
| 1 | 1 | 1 | 1 | 2 | 1 | 2 | 0, 1, 2, 3, 4, 6 | 2 | 2 |
| 2 | 1 | 0, 1 | 1 | 2 | 2 | 2 | 0, 1, 2, 3, 4, 5, 6 | 2 | 2 |
| 3 | 2 | 0 | 1 | 2 | 3 | 2 | 0, 1, 2, 3, 4, 5, 6, 7 | 2 | 2 |
| 4 | 2 | 1 | 1 | 2 | 4-31 | reserved | reserved | reserved | |
| 5 | 2 | 2 | 1 | 2 | | | | | |
| 6 | 2 | 3 | 1 | 2 | | | | | |
| 7 | 2 | 0, 1 | 1 | 2 | | | | | |
| 8 | 2 | 2, 3 | 1 | 2 | | | | | |
| 9 | 2 | 0-2 | 1 | 2 | | | | | |
| 10 | 2 | 0-3 | 1 | 2 | | | | | |
| 11 | 2 | 0, 2 | 1 | 2 | | | | | |
| 12 | 2 | 0 | 2 | 2 | | | | | |
| 13 | 2 | 1 | 2 | 2 | | | | | |
| 14 | 2 | 2 | 2 | 2 | | | | | |
| 15 | 2 | 3 | 2 | 2 | | | | | |
| 16 | 2 | 4 | 2 | 2 | | | | | |
| 17 | 2 | 5 | 2 | 2 | | | | | |
| 18 | 2 | 6 | 2 | 2 | | | | | |
| 19 | 2 | 7 | 2 | 2 | | | | | |
| 20 | 2 | 0, 1 | 2 | 2 | | | | | |
| 21 | 2 | 2, 3 | 2 | 2 | | | | | |
| 22 | 2 | 4, 5 | 2 | 2 | | | | | |
| 23 | 2 | 6, 7 | 2 | 2 | | | | | |
| 24 | 2 | 0, 4 | 2 | 2 | | | | | |
| 25 | 2 | 2, 6 | 2 | 2 | | | | | |
| 26 | 2 | 0, 1, 4 | 2 | 2 | | | | | |
| 27 | 2 | 2, 3, 6 | 2 | 2 | | | | | |
| 28 | 2 | 0, 1, 4, 5 | 2 | 2 | | | | | |
| 29 | 2 | 2, 3, 6, 7 | 2 | 2 | | | | | |
| 30 | 2 | 0, 2, 4, 6 | 2 | 2 | | | | | |
| 31 | 2 | 0, 2, 3 | 1 | 2 | | | | | |
| 32 | 2 | 0 | 1 | M | | | | | |
| 33 | 2 | 1 | 1 | M | | | | | |
| 34 | 2 | 2 | 1 | M | | | | | |
| 35 | 2 | 3 | 1 | M | | | | | |
| 36 | 2 | 8 | 1 | M | | | | | |
| 37 | 2 | 9 | 1 | M | | | | | |
| 38 | 2 | 10 | 1 | M | | | | | |
| 39 | 2 | 11 | 1 | M | | | | | |
| 40 | 2 | 0, 1 | 1 | M | | | | | |
| 41 | 2 | 2, 3 | 1 | M | | | | | |
| 42 | 2 | 8, 9 | 1 | M | | | | | |
| 43 | 2 | 10, 11 | 1 | M | | | | | |
| 44 | 2 | 0, 1, 8 | 1 | M | | | | | |
| 45 | 2 | 2, 3, 10 | 1 | M | | | | | |
| 46 | 2 | 0, 1, 8, 9 | 1 | M | | | | | |
| 47 | 2 | 2, 3, 10, 11 | 1 | M | | | | | |
| 48 | 2 | 0, 1, 2 | 1 | M | | | | | |
| 49 | 2 | 8, 9, 10 or | 1 | M | | | | | |
| | | 8, 10, 11 | | | | | | | |
| 50 | 2 | 0, 2, 3 | 1 | M | | | | | |
| 51 | 2 | 0 | 2 | M | | | | | |
| 52 | 2 | 1 | 2 | M | | | | | |
| 53 | 2 | 2 | 2 | M | | | | | |
| 54 | 2 | 3 | 2 | M | | | | | |
| 55 | 2 | 4 | 2 | M | | | | | |
| 56 | 2 | 5 | 2 | M | | | | | |
| 57 | 2 | 6 | 2 | M | | | | | |
| 58 | 2 | 7 | 2 | M | | | | | |
| 59 | 2 | 8 | 2 | M | | | | | |
| 60 | 2 | 9 | 2 | M | | | | | |
| 61 | 2 | 10 | 2 | M | | | | | |
| 61 | 2 | 11 | 2 | M | | | | | |
| 63 | 2 | 12 | 2 | M | | | | | |
| 64 | 2 | 13 | 2 | M | | | | | |
| 65 | 2 | 14 | 2 | M | | | | | |
| 66 | 2 | 15 | 2 | M | | | | | |
| 67 | 2 | 0, 1 | 2 | M | | | | | |
| 68 | 2 | 2, 3 | 2 | M | | | | | |
| 69 | 2 | 4, 5 | 2 | M | | | | | |
| 70 | 2 | 6, 7 | 2 | M | | | | | |
| 71 | 2 | 0, 4 | 2 | M | | | | | |
| 72 | 2 | 2, 6 | 2 | M | | | | | |
| 73 | 2 | 8, 9 | 2 | M | | | | | |
| 74 | 2 | 10, 11 | 2 | M | | | | | |
| 75 | 2 | 12, 13 | 2 | M | | | | | |
| 76 | 2 | 14, 15 | 2 | M | | | | | |
| 77 | 2 | 0, 1, 4 | 2 | M | | | | | |
| 78 | 2 | 2, 3, 6 | 2 | M | | | | | |
| 79 | 2 | 8, 9, 12 | 2 | M | | | | | |
| 80 | 2 | 10, 11, 14 | 2 | M | | | | | |
| 81 | 2 | 0, 1, 4, 5 or | 2 | M | | | | | |
| | | 0, 1, 2, 3 | | | | | | | |
| 82 | 2 | 2, 3, 6, 7 or | 2 | M | | | | | |
| | | 4, 5, 6, 7 | | | | | | | |
| 83 | 2 | 8, 9, 12, 13 or | 2 | M | | | | | |
| | | 8, 9, 10, 11 | | | | | | | |
| 84 | 2 | 10, 11, 14, 15 | 2 | M | | | | | |
| | | or | | | | | | | |
| | | 12, 13, 14, 15 | | | | | | | |

In the above table 2, item 31 may be used for the scenario of multi-TRP. For example, 2 or 3 or 4 TCI states are indicated and the indicated DMRS ports are comprised in two CDM groups. In some embodiments, the item 31 may not be comprised in the table 2. In one 5 example embodiment, only one TCI state is indicated. In another example embodiment, the indicated DMRS port(s) is comprised in one CDM group.

In the above table 2, items 48 to 50 may be used for the scenario of multi-TRP and MU. For example, 2 or 3 or 4 TCI states are indicated and the indicated DMRS ports are comprised in two CDM groups. In some embodiments, the items 48 to 50 may not be comprised in the table 2. In one example embodiment, only one TCI state is indicated. In another example embodiment, the indicated DMRS port(s) is comprised in one CDM group.

In some embodiments, there may be no need of so many single-port DMRS indications. Thus, in some embodiments, if the maximum number of co-scheduled single-layer UEs is limited, at least one of items 63 to 65 and/or at least one of items 51 to 54 is not needed and not comprised in the table 2.

In some embodiments, TD-OCC (e.g. in case of large delay spread and small doppler) is used, while for new DMRS ports, there is no need, as new DMRS ports are multiplexed with larger FD-OCC, which is not suitable for the target. In view of this, at least one indication of items of 71 and 72 may be not comprised in the table 2.

Below table 3 illustrates a further example of downlink DMRS table, where the length of FD=OCC is M and M is 4 or 6.

TABLE 3
Antenna port(s) (1000 + DMRS port), dmrs-Type = 2, maxLength = 1

| One codeword: | | | | Two codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | | | DMRS CDM | | |
| | group(s) | | | | group(s) | | |
| | without | DMRS | FD-OCC | | without | DMRS | FD-OCC |
| Value | data | port(s) | length | Value | data | port(s) | length |
| 0 | 1 | 0 | 2 | 0 | 3 | 0-4 | 2 |
| 1 | 1 | 1 | 2 | 1 | 3 | 0-5 | 2 |
| 2 | 1 | 0, 1 | 2 | | 3 | 0, 1, 2, 3, 4, 5, 12 | M |
| 3 | 2 | 0 | 2 | | 3 | 0, 1, 2, 3, 4, 5, 12, 14 | M |
| 4 | 2 | 1 | 2 | | | | |
| 5 | 2 | 2 | 2 | | | | |
| 6 | 2 | 3 | 2 | | | | |
| 7 | 2 | 0, 1 | 2 | | | | |
| 8 | 2 | 2, 3 | 2 | | | | |
| 9 | 2 | 0-2 | 2 | | | | |
| 10 | 2 | 0-3 | 2 | | | | |
| 11 | 3 | 0 | 2 | | | | |
| 12 | 3 | 1 | 2 | | | | |
| 13 | 3 | 2 | 2 | | | | |
| 14 | 3 | 3 | 2 | | | | |
| 15 | 3 | 4 | 2 | | | | |
| 16 | 3 | 5 | 2 | | | | |
| 17 | 3 | 0, 1 | 2 | | | | |
| 18 | 3 | 2, 3 | 2 | | | | |
| 19 | 3 | 4, 5 | 2 | | | | |
| 20 | 3 | 0-2 | 2 | | | | |
| 21 | 3 | 3-5 | 2 | | | | |
| 22 | 3 | 0-3 | 2 | | | | |
| 23 | 2 | 0, 2 | 2 | | | | |
| 24 | 2 | 0, 2, 3 | 2 | | | | |
| 25 | 3 | 0 | M | | | | |
| 26 | 3 | 1 | M | | | | |
| 27 | 3 | 2 | M | | | | |
| 28 | 3 | 3 | M | | | | |
| 29 | 3 | 4 | M | | | | |
| 30 | 3 | 5 | M | | | | |
| 31 | 3 | 12 | M | | | | |
| 32 | 3 | 13 | M | | | | |
| 33 | 3 | 14 | M | | | | |
| 34 | 3 | 15 | M | | | | |
| 35 | 3 | 16 | M | | | | |
| 36 | 3 | 17 | M | | | | |
| 37 | 3 | 0, 1 | M | | | | |
| 38 | 3 | 2, 3 | M | | | | |
| 39 | 3 | 4, 5 | M | | | | |
| 40 | 3 | 12, 13 | M | | | | |
| 41 | 3 | 14, 15 | M | | | | |
| 42 | 3 | 16, 17 | M | | | | |
| 43 | 3 | 0-2 | M | | | | |
| 44 | 3 | 3-5 | M | | | | |
| 45 | 3 | 12, 13, 14 | M | | | | |
| 46 | 3 | 15, 16, 17 | M | | | | |
| 47 | 3 | 0, 1, 12, 13 | M | | | | |
| 48 | 3 | 2, 3, 14, 15 | M | | | | |
| 49 | 3 | 4, 5, 16, 17 | M | | | | |
| 50 | 3 | 0, 2, 3 | M | | | | |
| 51 | 3 | 12, 14, 15 | M | | | | |

In the above table 3, items 24 may be used for the scenario of multi-TRP. For example, 2 or 3 or 4 transmission configuration indication (TCI) states are indicated and the indicated DMRS ports are comprised in two CDM groups. In some embodiments, the item 24 may not be comprised in the table 3. For example, only one TC state is indicated. For another example, the indicated DMRS port(s) is comprised in one CDM group.

In the above table 3, items 50 and 51 may be used for the scenario of multi-TRP and MU. For example, 2 or 3 or 4 transmission configuration indication (TCI) states are indicated and the indicated DMRS ports are comprised in two CDM groups. In some embodiments, the items 50 and 51 may not be comprised in the table 3. For example, only one T state is indicated. For another example, the indicated DMRS port(s) is comprised in one CDM group.

Below table 4 illustrates an example of downlink DMRS table, where the length of FD=OCC is M and M is 4 or 6.

TABLE 4
Antenna port(s) (1000 + DMRS port), dmrs-Type = 2, maxLength = 2

| One codeword: | | | | | Two Codewords: | | | | |
|---|---|---|---|---|---|---|---|---|---|
| Codeword 0 enabled, | | | | | Codeword 0 enabled, | | | | |
| Codeword 1 disabled | | | | | Codeword 1 enabled | | | | |
| | Number of | | | | | Number of | | | |
| | DMRS CDM | | | | | DMRS CDM | | | |
| | group(s) | | Number of | | | group(s) | | Number of | |
| | without | DMRS | front-load | FD-OCC | | without | DMRS | front-load | FD-OCC |
| Value | data | port(s) | symbols | length | Value | data | port(s) | symbols | length |
| 0 | 1 | 0 | 1 | 2 | 0 | 3 | 0-4 | 1 | 2 |
| 1 | 1 | 1 | 1 | 2 | 1 | 3 | 0-5 | 1 | 2 |
| 2 | 1 | 0, 1 | 1 | 2 | | 3 | 0, 1, 2, 3, 4, 5, 12 | 1 | M |
| 3 | 2 | 0 | 1 | 2 | | 3 | 0, 1, 2, 3, 4, 5, 12, 14 | 1 | M |
| 4 | 2 | 1 | 1 | 2 | | 2 | 0, 1, 2, 3, 6 | 2 | 2 |
| 5 | 2 | 2 | 1 | 2 | | 2 | 0, 1, 2, 3, 6, 8 | 2 | 2 |
| 6 | 2 | 3 | 1 | 2 | | 2 | 0, 1, 2, 3, 6, 7, 8 | 2 | 2 |
| 7 | 2 | 0, 1 | 1 | 2 | | 2 | 0, 1, 2, 3, 6, 7, 8, 9 | 2 | 2 |
| 8 | 2 | 2, 3 | 1 | 2 | | | | | |
| 9 | 2 | 0-2 | 1 | 2 | | | | | |
| 10 | 2 | 0-3 | 1 | 2 | | | | | |
| 11 | 3 | 0 | 1 | 2 | | | | | |
| 12 | 3 | 1 | 1 | 2 | | | | | |
| 13 | 3 | 2 | 1 | 2 | | | | | |
| 14 | 3 | 3 | 1 | 2 | | | | | |
| 15 | 3 | 4 | 1 | 2 | | | | | |
| 16 | 3 | 5 | 1 | 2 | | | | | |
| 17 | 3 | 0, 1 | 1 | 2 | | | | | |
| 18 | 3 | 2, 3 | 1 | 2 | | | | | |
| 19 | 3 | 4, 5 | 1 | 2 | | | | | |
| 20 | 3 | 0-2 | 1 | 2 | | | | | |
| 21 | 3 | 3-5 | 1 | 2 | | | | | |
| 22 | 3 | 0-3 | 1 | 2 | | | | | |
| 23 | 2 | 0, 2 | 1 | 2 | | | | | |
| 24 | 3 | 0 | 2 | 2 | | | | | |
| 25 | 3 | 1 | 2 | 2 | | | | | |
| 26 | 3 | 2 | 2 | 2 | | | | | |
| 27 | 3 | 3 | 2 | 2 | | | | | |
| 28 | 3 | 4 | 2 | 2 | | | | | |
| 29 | 3 | 5 | 2 | 2 | | | | | |
| 30 | 3 | 6 | 2 | 2 | | | | | |
| 31 | 3 | 7 | 2 | 2 | | | | | |
| 32 | 3 | 8 | 2 | 2 | | | | | |
| 33 | 3 | 9 | 2 | 2 | | | | | |
| 34 | 3 | 10 | 2 | 2 | | | | | |
| 35 | 3 | 11 | 2 | 2 | | | | | |
| 36 | 3 | 0, 1 | 2 | 2 | | | | | |
| 37 | 3 | 2, 3 | 2 | 2 | | | | | |
| 38 | 3 | 4, 5 | 2 | 2 | | | | | |
| 39 | 3 | 6, 7 | 2 | 2 | | | | | |
| 40 | 3 | 8, 9 | 2 | 2 | | | | | |
| 41 | 3 | 10, 11 | 2 | 2 | | | | | |
| 42 | 3 | 0, 1, 6 | 2 | 2 | | | | | |
| 43 | 3 | 2, 3, 8 | 2 | 2 | | | | | |
| 44 | 3 | 4, 5, 10 | 2 | 2 | | | | | |
| 45 | 3 | 0, 1, 6, 7 | 2 | 2 | | | | | |
| 46 | 3 | 2, 3, 8, 9 | 2 | 2 | | | | | |
| 47 | 3 | 4, 5, 10, 11 | 2 | 2 | | | | | |
| 48 | 1 | 0 | 2 | 2 | | | | | |
| 49 | 1 | 1 | 2 | 2 | | | | | |
| 50 | 1 | 6 | 2 | 2 | | | | | |
| 51 | 1 | 7 | 2 | 2 | | | | | |
| 52 | 1 | 0, 1 | 2 | 2 | | | | | |
| 53 | 1 | 6, 7 | 2 | 2 | | | | | |
| 54 | 2 | 0, 1 | 2 | 2 | | | | | |
| 55 | 2 | 2, 3 | 2 | 2 | | | | | |
| 56 | 2 | 6, 7 | 2 | 2 | | | | | |
| 57 | 2 | 8, 9 | 2 | 2 | | | | | |
| 58 | 2 | 0, 2, 3 | 1 | 2 | | | | | |
| 59 | 3 | 0 | 1 | M | | | | | |
| 60 | 3 | 1 | 1 | M | | | | | |
| 61 | 3 | 2 | 1 | M | | | | | |
| 61 | 3 | 3 | 1 | M | | | | | |
| 63 | 3 | 4 | 1 | M | | | | | |
| 64 | 3 | 5 | 1 | M | | | | | |
| 65 | 3 | 12 | 1 | M | | | | | |
| 66 | 3 | 13 | 1 | M | | | | | |
| 67 | 3 | 14 | 1 | M | | | | | |
| 68 | 3 | 15 | 1 | M | | | | | |
| 69 | 3 | 16 | 1 | M | | | | | |
| 70 | 3 | 17 | 1 | M | | | | | |
| 71 | 3 | 0, 1 | 1 | M | | | | | |
| 72 | 3 | 2, 3 | 1 | M | | | | | |
| 73 | 3 | 4, 5 | 1 | M | | | | | |
| 74 | 3 | 12, 13 | 1 | M | | | | | |
| 75 | 3 | 14, 15 | 1 | M | | | | | |
| 76 | 3 | 16, 17 | 1 | M | | | | | |
| 77 | 3 | 0-2 | 1 | M | | | | | |
| 78 | 3 | 3-5 | 1 | M | | | | | |
| 79 | 3 | 12, 13, 14 | 1 | M | | | | | |
| 80 | 3 | 15, 16, 17 | 1 | M | | | | | |
| 81 | 3 | 0, 1, 12, 13 | 1 | M | | | | | |
| 82 | 3 | 2, 3, 14, 15 | 1 | M | | | | | |
| 83 | 3 | 4, 5, 16, 17 | 1 | M | | | | | |
| 84 | 3 | 0 | 2 | M | | | | | |
| 85 | 3 | 1 | 2 | M | | | | | |
| 86 | 3 | 2 | 2 | M | | | | | |
| 87 | 3 | 3 | 2 | M | | | | | |
| 88 | 3 | 4 | 2 | M | | | | | |
| 89 | 3 | 5 | 2 | M | | | | | |
| 90 | 3 | 6 | 2 | M | | | | | |
| 91 | 3 | 7 | 2 | M | | | | | |
| 92 | 3 | 8 | 2 | M | | | | | |
| 93 | 3 | 9 | 2 | M | | | | | |
| 94 | 3 | 10 | 2 | M | | | | | |
| 95 | 3 | 11 | 2 | M | | | | | |
| 96 | 3 | 12 | 2 | M | | | | | |
| 97 | 3 | 13 | 2 | M | | | | | |
| 98 | 3 | 14 | 2 | M | | | | | |
| 99 | 3 | 15 | 2 | M | | | | | |
| 100 | 3 | 16 | 2 | M | | | | | |
| 101 | 3 | 17 | 2 | M | | | | | |
| 102 | 3 | 18 | 2 | M | | | | | |
| 103 | 3 | 19 | 2 | M | | | | | |
| 104 | 3 | 20 | 2 | M | | | | | |
| 105 | 3 | 21 | 2 | M | | | | | |
| 106 | 3 | 22 | 2 | M | | | | | |
| 107 | 3 | 23 | 2 | M | | | | | |
| 108 | 3 | 0, 1 | 2 | M | | | | | |
| 109 | 3 | 2, 3 | 2 | M | | | | | |
| 110 | 3 | 4, 5 | 2 | M | | | | | |
| 111 | 3 | 6, 7 | 2 | M | | | | | |
| 112 | 3 | 8, 9 | 2 | M | | | | | |
| 113 | 3 | 10, 11 | 2 | M | | | | | |
| 114 | 3 | 12, 13 | 2 | M | | | | | |
| 115 | 3 | 14, 15 | 2 | M | | | | | |
| 116 | 3 | 16, 17 | 2 | M | | | | | |
| 117 | 3 | 18, 19 | 2 | M | | | | | |
| 118 | 3 | 20, 21 | 2 | M | | | | | |
| 119 | 3 | 22, 23 | 2 | M | | | | | |
| 120 | 3 | 0, 1, 6 | 2 | M | | | | | |
| 121 | 3 | 2, 3, 8 | 2 | M | | | | | |
| 122 | 3 | 4, 5, 10 | 2 | M | | | | | |
| 123 | 3 | 12, 13, 18 | 2 | M | | | | | |
| 124 | 3 | 14, 15, 20 | 2 | M | | | | | |
| 125 | 3 | 16, 17, 21 | 2 | M | | | | | |
| 126 | 3 | 0, 1, 6, 7 | 2 | M | | | | | |
| 127 | 3 | 2, 3, 8, 9 | 2 | M | | | | | |
| 128 | 3 | 4, 5, 10, 11 | 2 | M | | | | | |
| 129 | 3 | 12, 13, 18, 19 | 2 | M | | | | | |
| 130 | 3 | 14, 15, 20, 21 | 2 | M | | | | | |
| 131 | 3 | 16, 17, 22, 23 | 2 | M | | | | | |
| 132 | 3 | 0, 2, 3 | 2 | M | | | | | |
| 133 | 3 | 12, 14, 15 | 2 | M | | | | | |

In the above table 4, item 58 may be used for the scenario of multi-TRP. For example, 2 or 3 or 4 TCI states are indicated and the indicated DMRS ports are comprised in two CDM groups. In some embodiments, the item 58 may not be comprised in the table 4. In one example embodiment, only one TCI state is indicated. In another example embodiment, the indicated DMRS port(s) is comprised in one CDM group.

In some embodiments, there may be no need of so many single-port DMRS indications. Thus, in some embodiments, if the maximum number of co-scheduled single-layer UEs is limited, at least one of items 84 to 95 or at least one of items 100 to 107 or at least one of items 84 to 91 is not needed and not be comprised in the table 4.

In the above table 4, items 132 and 133 may be used for the scenario of multi-TRP and MU. For example, 2 or 3 or 4 TCI states are indicated and the indicated DMRS ports are comprised in two CDM groups. In some embodiments, the items 132 and 133 may not be comprised in the table 4. In one example embodiment, only one TCI state is indicated. In another example embodiment, the indicated DMRS port(s) is comprised in one CDM group.

Below table 5 illustrates an example of uplink DMRS table, where the length of FD=OCC is M and M is 4 or 6. In some embodiments, there is no need to indicate FD-OCC length, then, there is no need of duplicated indications of same DMRS port(s) with different FD-OCC length.

TABLE 5
Antenna port(s), dmrs-Type = 1, maxLength = 1

| One Codeword: | | | Two Codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS | | | DMRS | |
| | CDM | | | CDM | |
| | group(s) | DMRS | | group(s) | DMRS |
| Value | without data | port(s) | Value | without data | port(s) |
| 0 | 1 | 0 | 0 | 2 | 0, 1, 2, 3, 8 |
| 1 | 1 | 1 | 1 | 2 | 0, 1, 2, 3, 8, 10 |
| 2 | 1 | 0, 1 | 2 | 2 | 0, 1, 2, 3, 8, 9, 10 |
| 3 | 2 | 0 | 3 | 2 | 0, 1, 2, 3, 8, 9, 10, 11 |
| 4 | 2 | 1 | 4-31 | reserved | reserved |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 2 | 0, 2 | | | |
| 12 | 2 | 0, 2, 3 | | | |
| 13 | 2 | 8 | | | |
| 14 | 2 | 9 | | | |
| 15 | 2 | 10 | | | |
| 16 | 2 | 11 | | | |
| 17 | 2 | 8, 9 | | | |
| 18 | 2 | 10, 11 | | | |
| 19 | 2 | 0, 1, 8 | | | |
| 20 | 2 | 2, 3, 10 | | | |
| 21 | 2 | 0, 1, 8, 9 | | | |
| 22 | 2 | 2, 3, 10, 11 | | | |
| 23 | 2 | 8, 9, 10 | | | |
| 24 | 2 | 8, 10, 11 | | | |
| 25 | 2 | 0, 1, 2, 3 | | | |
| 26 | 2 | 8, 9, 10, 11 | | | |

In the above table 5, item 12 may be used for the scenario of multi-TRP. For example, 2 sounding reference signal (SRS) resource indications (SRIs) and/or 2 transmission precoding matrix indications (TPMIs) and/or 2 precoding matrix indications (PMIs) and/or 2 rank indications (RIs) are indicated and the indicated DMRS ports are comprised in two CDM groups.

In some embodiments, the item 58 may not be comprised in the table 5. In one example embodiment, only one SRI and/or RI and/or TPMI and/or PMI is indicated. In another example embodiment, the indicated DMRS port(s) is comprised in one CDM group.

In the above table 5, item 24 may be used for the scenario of multi-TRP and MU. For example, 2 SRIs and/or 2 TPMIs and/or 2 PMIs and/or 2 RIs are indicated and the indicated DMRS ports are comprised in two CDM groups. In some embodiments, the item 24 may not be comprised in the table 5. In one example embodiment, only one SRI and/or RI and/or TPMI and/or PMI is indicated. In another example embodiment, the indicated DMRS port(s) is comprised in one CDM group.

In some embodiments, the items 35 and 26 may not be comprised in above table 5.

Below table 6 illustrates an example of uplink DMRS table, where the length of FD=OCC is M and M is 4 or 6.

TABLE 6
Antenna port(s), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | | | DMRS CDM | | |
| | group(s) | | Number of | | group(s) | | Number of |
| | without | DMRS | front-load | | without | DMRS | front-load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |
| 32 | 2 | 8 | 1 | | | | |
| 33 | 2 | 9 | 1 | | | | |
| 34 | 2 | 10 | 1 | | | | |
| 35 | 2 | 11 | 1 | | | | |
| 36 | 2 | 8, 9 | 1 | | | | |
| 37 | 2 | 10, 11 | 1 | | | | |
| 38 | 2 | 0, 1, 8 | 1 | | | | |
| 39 | 2 | 2, 3, 10 | 1 | | | | |
| 40 | 2 | 0, 1, 8, 9 | 1 | | | | |
| 41 | 2 | 2, 3, 10, 11 | 1 | | | | |
| 42 | 2 | 8, 9, 10 or | 1 | | | | |
| | | 8, 10, 11 | | | | | |
| 43 | 2 | 8 | 2 | | | | |
| 44 | 2 | 9 | 2 | | | | |
| 45 | 2 | 10 | 2 | | | | |
| 46 | 2 | 11 | 2 | | | | |
| 47 | 2 | 12 | 2 | | | | |
| 48 | 2 | 13 | 2 | | | | |
| 49 | 2 | 14 | 2 | | | | |
| 50 | 2 | 15 | 2 | | | | |
| 51 | 2 | 8, 9 | 2 | | | | |
| 52 | 2 | 10, 11 | 2 | | | | |
| 53 | 2 | 12, 13 | 2 | | | | |
| 54 | 2 | 14, 15 | 2 | | | | |
| 55 | 2 | 8, 9, 12 | 2 | | | | |
| 56 | 2 | 10, 11, 14 | 2 | | | | |
| 57 | 2 | 0, 1, 2, 3 | 2 | | | | |
| 58 | 2 | 4, 5, 6, 7 | 2 | | | | |
| 59 | 2 | 8, 9, 12, 13 or | 2 | | | | |
| | | 8, 9, 10, 11 | | | | | |
| 60 | 2 | 10, 11, 14, 15 | 2 | | | | |
| | | or | | | | | |
| | | 12, 13, 14, 15 | | | | | |

In the above table 6, item 31 may be used for the scenario of multi-TRP. For example, 2 SRIs and/or 2 TPMIs and/or 2 PMIs and/or 2 RIs are indicated and the indicated DMRS ports are comprised in two CDM groups. In some embodiments, the item 31 may not be comprised in the table 6. In one example embodiment, only one SRI and/or RI and/or TPMI and/or PMI is indicated. In another example embodiment, the indicated DMRS port(s) is comprised in one CDM group.

In the above table 6, item 42 may be used for the scenario of multi-TRP and MU. For example, 2 SRIs and/or 2 TPMIs and/or 2 PMIs and/or 2 RIs are indicated and the indicated DMRS ports are comprised in two CDM groups. In some embodiments, the item 42 may not be comprised in the table 6. In one example embodiment, only one SRI and/or RI and/or TPMI and/or PMI is indicated. In another example embodiment, the indicated DMRS port(s) is comprised in one CDM group.

In some embodiments, there may be no need of so many single-port DMRS indications. Thus, in some embodiments, if the maximum number of co-scheduled single-layer UEs is limited, at least one of items 47 to 50 or at least one of items 43 to 50 is not needed and not be comprised in the table 6.

Below table 7 illustrates an example of uplink DMRS table, where the length of FD=OCC is M and M is 4 or 6.

TABLE 7
Antenna port(s), dmrs-Type = 2, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of | | | Number of | |
| | DMRS | | | DMRS | |
| | CDM | | | CDM | |
| | group(s) | DMRS | | group(s) | DMRS |
| Value | without data | port(s) | Value | without data | port(s) |
| 0 | 1 | 0 | 0 | 3 | 0-4 |
| 1 | 1 | 1 | 1 | 3 | 0-5 |
| 2 | 1 | 0, 1 | | 3 | 0, 1, 2, 3, 4, 5, 12 |
| 3 | 2 | 0 | | 3 | 0, 1, 2, 3, 4, 5, 12, 14 |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 2 | 0, 2, 3 | | | |
| 25 | 3 | 12 | | | |
| 26 | 3 | 13 | | | |
| 27 | 3 | 14 | | | |
| 28 | 3 | 15 | | | |
| 29 | 3 | 16 | | | |
| 30 | 3 | 17 | | | |
| 31 | 3 | 12, 13 | | | |
| 32 | 3 | 14, 15 | | | |
| 33 | 3 | 16, 17 | | | |
| 34 | 3 | 12, 13, 14 | | | |
| 35 | 3 | 15, 16, 17 | | | |
| 36 | 3 | 0, 1, 12, 13 | | | |
| 37 | 3 | 2, 3, 14, 15 | | | |
| 38 | 3 | 4, 5, 16, 17 | | | |

In the above table 7, item 24 may be used for the scenario of multi-TRP. For example, 2 SRIs and/or 2 TPMIs and/or 2 PMIs and/or 2 RIs are indicated and the indicated DMRS ports are comprised in two CDM groups. In some embodiments, the item 24 may not be comprised in the table 7. In one example embodiment, only one SRI and/or RI and/or TPMI and/or PMI is indicated. In another example embodiment, the indicated DMRS port(s) is comprised in one CDM group.

In some embodiments, there may be no need of so many single-port DMRS indications. Thus, in some embodiments, if the maximum number of co-scheduled single-layer UEs is limited, at least one of items 25 to 30 or at least one of items 27 to 30 is not needed and not be comprised in the table 7.

Below table 8 illustrates an example of uplink DMRS table, where the length of FD=OCC is M and M is 4 or 6.

TABLE 8
Antenna port(s), dmrs-Type = 2, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | | | DMRS CDM | | |
| | group(s) | | Number of | | group(s) | | Number of |
| | without | DMRS | front-load | | without | DMRS | front-load |
| Value | data | port(s) | symbols | Value | data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | | 3 | 0, 1, 2, 3, 4, 5, 12 | 1 |
| 3 | 2 | 0 | 1 | | 3 | 0, 1, 2, 3, 4, 5, 12, 14 | 1 |
| 4 | 2 | 1 | 1 | | 2 | 0, 1, 2, 3, 6 | 2 |
| 5 | 2 | 2 | 1 | | 2 | 0, 1, 2, 3, 6, 8 | 2 |
| 6 | 2 | 3 | 1 | | 2 | 0, 1, 2, 3, 6, 7, 8 | 2 |
| 7 | 2 | 0, 1 | 1 | | 2 | 0, 1, 2, 3, 6, 7, 8, 9 | 2 |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 2 | 0, 2, 3 | 1 | | | | |
| 55 | 3 | 12 | 1 | | | | |
| 56 | 3 | 13 | 1 | | | | |
| 57 | 3 | 14 | 1 | | | | |
| 58 | 3 | 15 | 1 | | | | |
| 59 | 3 | 16 | 1 | | | | |
| 60 | 3 | 17 | 1 | | | | |
| 61 | 3 | 12, 13 | 1 | | | | |
| 61 | 3 | 14, 15 | 1 | | | | |
| 63 | 3 | 16, 17 | 1 | | | | |
| 64 | 3 | 12, 13, 14 | 1 | | | | |
| 65 | 3 | 15, 16, 17 | 1 | | | | |
| 66 | 3 | 0, 1, 12, 13 | 1 | | | | |
| 67 | 3 | 2, 3, 14, 15 | 1 | | | | |
| 68 | 3 | 4, 5, 16, 17 | 1 | | | | |
| 69 | 3 | 12 | 2 | | | | |
| 70 | 3 | 13 | 2 | | | | |
| 71 | 3 | 14 | 2 | | | | |
| 72 | 3 | 15 | 2 | | | | |
| 73 | 3 | 16 | 2 | | | | |
| 74 | 3 | 17 | 2 | | | | |
| 75 | 3 | 18 | 2 | | | | |
| 76 | 3 | 19 | 2 | | | | |
| 77 | 3 | 20 | 2 | | | | |
| 78 | 3 | 21 | 2 | | | | |
| 79 | 3 | 22 | 2 | | | | |
| 80 | 3 | 23 | 2 | | | | |
| 81 | 3 | 12, 13 | 2 | | | | |
| 82 | 3 | 14, 15 | 2 | | | | |
| 83 | 3 | 16, 17 | 2 | | | | |
| 84 | 3 | 18, 19 | 2 | | | | |
| 85 | 3 | 20, 21 | 2 | | | | |
| 86 | 3 | 22, 23 | 2 | | | | |
| 87 | 3 | 12, 13, 18 | 2 | | | | |
| 88 | 3 | 14, 15, 20 | 2 | | | | |
| 89 | 3 | 16, 17, 21 | 2 | | | | |
| 90 | 3 | 12, 13, 18, 19 | 2 | | | | |
| 91 | 3 | 14, 15, 20, 21 | 2 | | | | |
| 92 | 3 | 16, 17, 22, 23 | 2 | | | | |

In the above table 8, item 58 may be used for the scenario of multi-TRP. For example, 2 SRIs and/or 2 TPMIs and/or 2 PMIs and/or 2 RIs are indicated and the indicated DMRS ports are comprised in two CDM groups. In some embodiments, the item 58 may not be comprised in the table 8. In one example embodiment, only one SRI and/or RI and/or TPMI and/or PMI is indicated. In another example embodiment, the indicated DMRS port(s) is comprised in one CDM group.

In some embodiments, there may be no need of so many single-port DMRS indications. Thus, in some embodiments, if the maximum number of co-scheduled single-layer UEs is limited, at least one of items 69 to 80 or at least one of items 73 to 80 is not needed and not be comprised in the table 8.

Below tables 9 to 39 illustrates an example of uplink DMRS table, where the length of FD=OCC is M and M is 4 or 6. In some embodiments, there is no need to indicate FD-OCC length, then, there is no need of duplicated indications of same DMRS port(s) with different FD-OCC length.

Specifically, tables 9 to 23 are used for DMRS with the first DMRS type, and tables 24 to 39 are used for DMRS with the second DMRS type.

TABLE 9
Antenna port(s), transform precoder is disabled,
dmrs-Type = 1, maxLength = 1, rank = 1

| | Number of DMRS CDM group(s) | |
|---|---|---|
| Value | without data | DMRS port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 2 | 8 |
| 7 | 2 | 9 |
| 8 | 2 | 10 |
| 9 | 2 | 11 |

TABLE 10
Antenna port(s), transform precoder is disabled,
dmrs-Type = 1, maxLength = 1, rank = 2

| | Number of DMRS CDM group(s) | |
|---|---|---|
| Value | without data | DMRS port(s) |
| 0 | 1 | 0, 1 |
| 1 | 2 | 0, 1 |
| 2 | 2 | 2, 3 |
| 3 | 2 | 0, 2 |
| 4 | 2 | 8, 9 |
| 5 | 2 | 10, 11 |

TABLE 11
Antenna port(s), transform precoder is disabled,
dmrs-Type = 1, maxLength = 1, rank = 3

| | Number of DMRS CDM group(s) | |
|---|---|---|
| Value | without data | DMRS port(s) |
| 0 | 2 | 0-2 |
| 1 | 2 | 8, 9, 10 or 8, 10, 11 |
| . . . | | |

TABLE 12
Antenna port(s), transform precoder is disabled,
dmrs-Type = 1, maxLength = 1, rank = 4

| | Number of DMRS CDM group(s) | |
|---|---|---|
| Value | without data | DMRS port(s) |
| 0 | 2 | 0-3 |
| 1 | 2 | 0, 1, 8, 9 |
| 2 | 2 | 2, 3, 10, 11 |
| 3 | 2 | 8, 9, 10, 11 |
| . . . | | |

TABLE 13
Antenna port(s), transform precoder is disabled,
dmrs-Type = 1, maxLength = 1, rank = 5

| | Number of DMRS CDM group(s) | |
|---|---|---|
| Value | without data | DMRS port(s) |
| 0 | 2 | 0, 1, 2, 3, 8 |
| . . . | | |

TABLE 14
Antenna port(s), transform precoder is disabled,
dmrs-Type = 1, maxLength = 1, rank = 6

| | Number of DMRS CDM group(s) | |
|---|---|---|
| Value | without data | DMRS port(s) |
| 0 | 2 | 0, 1, 2, 3, 8, 10 |
| . . . | | |

TABLE 15
Antenna port(s), transform precoder is disabled,
dmrs-Type = 1, maxLength = 1, rank = 7

| | Number of DMRS CDM group(s) | |
|---|---|---|
| Value | without data | DMRS port(s) |
| 0 | 2 | 0, 1, 2, 3, 8, 9, 10 |
| . . . | | |

TABLE 16
Antenna port(s), transform precoder is disabled,
dmrs-Type = 1, maxLength = 1, rank = 8

| | Number of DMRS CDM group(s) | |
|---|---|---|
| Value | without data | DMRS port(s) |
| 0 | 2 | 0, 1, 2, 3, 8, 9, 10, 11 |
| . . . | | |

TABLE 17
Antenna port(s), transform precoder is disabled,
dmrs-Type = 1, maxLength = 2, rank = 1

| | Number of DMRS | | Number of |
|---|---|---|---|
| | CDM group(s) | | front-load |
| Value | without data | DMRS port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14 | 2 | 8 | 1 |
| 15 | 2 | 9 | 1 |
| 16 | 2 | 10 | 1 |
| 17 | 2 | 11 | 1 |
| 18 | 2 | 8 | 2 |
| 19 | 2 | 9 | 2 |
| 20 | 2 | 10 | 2 |
| 21 | 2 | 11 | 2 |
| 22 | 2 | 12 | 2 |
| 23 | 2 | 13 | 2 |
| 24 | 2 | 14 | 2 |
| 25 | 2 | 15 | 2 |

In some embodiments, if the maximum number of co-scheduled single-layer UEs is limited, at least one of items 22 to 25 is not needed and not comprised in above table 17.

TABLE 18
Antenna port(s), transform precoder is disabled,
dmrs-Type = 1, maxLength = 2, rank = 2

| | Number of DMRS | | Number of |
|---|---|---|---|
| | CDM group(s) | | front-load |
| Value | without data | DMRS port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10 | 2 | 8, 9 | 1 |
| 11 | 2 | 10, 11 | 1 |
| 12 | 2 | 8, 9 | 2 |
| 13 | 2 | 10, 11 | 2 |
| 14 | 2 | 12, 13 | 2 |
| 15 | 2 | 14, 15 | 2 |

TABLE 19
Antenna port(s), transform precoder is disabled,
dmrs-Type = 1, maxLength-2, rank = 3

| | Number of DMRS | | Number of |
|---|---|---|---|
| | CDM group(s) | | front-load |
| Value | without data | DMRS port(s) | symbols |
| 0 | 2 | 0-2 | 1 |
| 1 | 2 | 0, 1, 4 | 2 |
| 2 | 2 | 2, 3, 6 | 2 |
| 3 | 2 | 8, 9, 10 or 8, 10, 11 | 1 |
| 4 | 2 | 8, 9, 12 | 2 |
| 5 | 2 | 10, 11, 14 | 2 |

TABLE 20
Antenna port(s), transform precoder is disabled,
dmrs-Type = 1, maxLength = 2, rank = 4

| | Number of DMRS | | Number of |
|---|---|---|---|
| | CDM group(s) | | front-load |
| Value | without data | DMRS port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4 | 2 | 8, 9, 10, 11 | 1 |
| 5 | 2 | 8, 9, 12, 13 | 2 |
| 6 | 2 | 10, 11, 14, 15 | 2 |

TABLE 21
Antenna port(s), transform precoder is disabled,
dmrs-Type = 1, maxLength = 2, rank = 5

| | Number of DMRS | | Number of |
|---|---|---|---|
| | CDM group(s) | | front-load |
| Value | without data | DMRS port(s) | symbols |
| 0 | 2 | 0, 1, 2, 3, 8 | 1 |
| 1 | 2 | 0, 1, 2, 3, 4 | 2 |

TABLE 22
Antenna port(s), transform precoder is disabled,
dmrs-Type = 1, maxLength = 2, rank = 6

| | Number of DMRS | | Number of |
|---|---|---|---|
| | CDM group(s) | | front-load |
| Value | without data | DMRS port(s) | symbols |
| 0 | 2 | 0, 1, 2, 3, 8, 10 | 1 |
| 1 | 2 | 0, 1, 2, 3, 4, 6 | 2 |

TABLE 23A
Antenna port(s), transform precoder is disabled,
dmrs-Type = 1, maxLength = 2, rank = 7

| | Number of DMRS | | Number of |
|---|---|---|---|
| | CDM group(s) | | front-load |
| Value | without data | DMRS port(s) | symbols |
| 0 | 2 | 0, 1, 2, 3, 8, 9, 10 | 1 |
| 1 | 2 | 0, 1, 2, 3, 4, 5, 6 | 2 |

TABLE 23B
Antenna port(s), transform precoder is disabled,
dmrs-Type = 1, maxLength = 2, rank = 8

| | Number of DMRS | | Number of |
|---|---|---|---|
| | CDM group(s) | | front-load |
| Value | without data | DMRS port(s) | symbols |
| 0 | 2 | 0, 1, 2, 3, 8, 9, 10, 11 | 1 |
| 1 | 2 | 0, 1, 2, 3, 4, 5, 6, 7 | 2 |

TABLE 24
Antenna port(s), transform precoder is disabled,
dmrs-Type = 2, maxLength = 1, rank = 1

| | Number of DMRS CDM group(s) | |
|---|---|---|
| Value | without data | DMRS port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12 | 3 | 12 |
| 13 | 3 | 13 |
| 14 | 3 | 14 |
| 15 | 3 | 15 |
| 16 | 3 | 16 |
| 17 | 3 | 17 |

In some embodiments, there may be no need of so many single-port DMRS indications. Thus, in some embodiments, if the maximum number of co-scheduled single-layer UEs is limited, at least one of items 12 to 17 or at least one of items 14 to 17 is not needed and not be comprised in the table 24.

TABLE 25
Antenna port(s), transform precoder is disabled,
dmrs-Type = 2, maxLength = 1, rank = 2

| | Number of DMRS CDM group(s) | |
|---|---|---|
| Value | without data | DMRS port(s) |
| 0 | 1 | 0, 1 |
| 1 | 2 | 0, 1 |
| 2 | 2 | 2, 3 |
| 3 | 3 | 0, 1 |
| 1 | 3 | 2, 3 |
| 5 | 3 | 4, 5 |
| 6 | 2 | 0, 2 |
| 7 | 3 | 12, 13 |
| 8 | 3 | 14, 15 |
| 9 | 3 | 16, 17 |

TABLE 26
Antenna port(s), transform precoder is disabled,
dmrs-Type = 2, maxLength = 1, rank = 3

| | Number of DMRS CDM group(s) | |
|---|---|---|
| Value | without data | DMRS port(s) |
| 0 | 2 | 0-2 |
| 1 | 3 | 0-2 |
| 2 | 3 | 3-5 |
| 3 | 3 | 12, 13, 14 |
| 4 | 3 | 15, 16, 17 |
| 5 | 1 or 2 or 3 | 0, 1, 12 |
| 6 | 2 or 3 | 2, 3, 14 |
| 7 | 3 | 4, 5, 16 |

TABLE 27
Antenna port(s), transform precoder is disabled,
dmrs-Type = 2, maxLength = 1, rank = 4

| | Number of DMRS CDM group(s) | |
|---|---|---|
| Value | without data | DMRS port(s) |
| 0 | 2 | 0-3 |
| 1 | 3 | 0-3 |
| 3 | 3 | 12, 13, 14, 15 |
| 4 | 3 | 4, 5, 16, 17 |
| 5 | 1 or 2 or 3 | 0, 1, 12, 13 |
| 6 | 2 or 3 | 2, 3, 14, 15 |

TABLE 28
Antenna port(s), transform precoder is disabled,
dmrs-Type = 2, maxLength = 1, rank = 5

| | Number of DMRS CDM group(s) | |
|---|---|---|
| Value | without data | DMRS port(s) |
| 0 | 3 | 0-4 |
| 1 | 2 | 0, 1, 2, 3, 12 |
| 2 | 3 | 0, 1, 2, 3, 12 |

TABLE 29
Antenna port(s), transform precoder is disabled,
dmrs-Type = 2, maxLength = 1, rank = 6

| | Number of DMRS CDM group(s) | |
|---|---|---|
| Value | without data | DMRS port(s) |
| 0 | 3 | 0-5 |
| 1 | 2 | 0, 1, 2, 3, 12, 14 |
| 2 | 3 | 0, 1, 2, 3, 12, 14 |

TABLE 30
Antenna port(s), transform precoder is disabled,
dmrs-Type = 2, maxLength = 1, rank = 7

| | Number of DMRS CDM group(s) | |
|---|---|---|
| Value | without data | DMRS port(s) |
| 0 | 2 | 0, 1, 2, 3, 12, 13, 14 |
| 1 | 3 | 0, 1, 2, 3, 12, 13, 14 |
| 2 | 3 | 0, 1, 2, 3, 4, 5, 12 |

TABLE 31
Antenna port(s), transform precoder is disabled,
dmrs-Type = 2, maxLength = 1, rank = 8

| | Number of DMRS CDM group(s) | |
|---|---|---|
| Value | without data | DMRS port(s) |
| 0 | 2 | 0, 1, 2, 3, 12, 13, 14, 15 |
| 1 | 3 | 0, 1, 2, 3, 12, 13, 14, 15 |
| 2 | 3 | 0, 1, 2, 3, 4, 5, 12, 14 |

TABLE 32
Antenna port(s), transform precoder is disabled,
dmrs-Type = 2, maxLength = 2, rank = 1

| | Number of DMRS | | Number of |
|---|---|---|---|
| | CDM group(s) | | front-load |
| Value | without data | DMRS port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28 | 3 | 12 | 1 |
| 29 | 3 | 13 | 1 |
| 30 | 3 | 14 | 1 |
| 31 | 3 | 15 | 1 |
| 32 | 3 | 16 | 1 |
| 33 | 3 | 17 | 1 |
| 34 | 3 | 12 | 2 |
| 35 | 3 | 13 | 2 |
| 36 | 3 | 14 | 2 |
| 37 | 3 | 15 | 2 |
| 38 | 3 | 16 | 2 |
| 39 | 3 | 17 | 2 |
| 40 | 3 | 18 | 2 |
| 41 | 3 | 19 | 2 |
| 42 | 3 | 20 | 2 |
| 43 | 3 | 21 | 2 |
| 44 | 3 | 22 | 2 |
| 45 | 3 | 23 | 2 |

In some embodiments, there may be no need of so many single-port DMRS indications. Thus, in some embodiments, if the maximum number of co-scheduled single-layer UEs is limited, at least one of items 28 to 45 or at least one of items 33 to 45 is not needed and not be comprised in the table 32.

TABLE 33
Antenna port(s), transform precoder is disabled,
dmrs-Type = 2, maxLength = 2, rank = 2

| | Number of DMRS | | Number of |
|---|---|---|---|
| | CDM group(s) | | front-load |
| Value | without data | DMRS port(s) | symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19 | 3 | 12, 13 | 1 |
| 20 | 3 | 14, 15 | 1 |
| 21 | 3 | 16, 17 | 1 |
| 22 | 3 | 12, 13 | 2 |
| 23 | 3 | 14, 15 | 2 |
| 24 | 3 | 16, 17 | 2 |
| 25 | 3 | 18, 19 | 2 |
| 26 | 3 | 20, 21 | 2 |
| 27 | 3 | 22, 23 | 2 |

TABLE 34
Antenna port(s), transform precoder is disabled,
dmrs-Type = 2, maxLength = 2, rank = 3

| | Number of DMRS | | Number of |
|---|---|---|---|
| | CDM group(s) | | front-load |
| Value | without data | DMRS port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6 | 3 | 12, 13, 14 | 1 |
| 7 | 3 | 15, 16, 17 | 1 |
| 8 | 1 or 2 or 3 | 0, 1, 12 | 1 |
| 9 | 2 or 3 | 2, 3, 14 | 1 |
| 10 | 3 | 4, 5, 16 | 1 |
| 11 | 3 | 12, 13, 18 | 2 |
| 12 | 3 | 14, 15, 20 | 2 |
| 13 | 3 | 16, 17, 22 | 2 |

TABLE 35
Antenna port(s), transform precoder is disabled,
dmrs-Type = 2, maxLength = 2, rank = 4

| | Number of DMRS | | Number of |
|---|---|---|---|
| | CDM group(s) | | front-load |
| Value | without data | DMRS port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5 | 3 | 12, 13, 14, 15 | 1 |
| 6 | 3 | 4, 5, 16, 17 | 1 |
| 7 | 1 or 2 or 3 | 0, 1, 12, 13 | 1 |
| 8 | 2 or 3 | 2, 3, 14, 15 | 1 |
| 9 | 3 | 12, 13, 18, 19 | 2 |
| 10 | 3 | 14, 15, 20, 21 | 2 |
| 11 | 3 | 16, 17, 22, 23 | 2 |

TABLE 36
Antenna port(s), transform precoder is disabled,
dmrs-Type = 2, maxLength = 1, rank = 5

| | Number of DMRS | | Number of |
|---|---|---|---|
| | CDM group(s) | | front-load |
| Value | without data | DMRS port(s) | symbols |
| 0 | 3 | 0-4 | 1 |
| 1 | 2 | 0, 1, 2, 3, 12 | 1 |
| 3 | 3 | 0, 1, 2, 3, 12 | 1 |
| 4 | 2 | 0, 1, 2, 3, 6 | 2 |
| 5 | 3 | 0, 1, 2, 3, 6 | 2 |
| 6 | 3 | 0, 1, 2, 3, 4 | 2 |
| 7 | 3 | 0, 1, 6, 7, 12 | 2 |
| 8 | 3 | 2, 3, 8, 9, 14 | 2 |
| 9 | 3 | 4, 5, 10, 11, 16 | 2 |

In some embodiments, at least one of items 7 to 9 is not needed and not comprised in above table 36.

TABLE 37
Antenna port(s), transform precoder is disabled,
dmrs-Type = 2, maxLength = 1, rank = 6

| | Number of DMRS | | Number of |
|---|---|---|---|
| | CDM group(s) | | front-load |
| Value | without data | DMRS port(s) | symbols |
| 0 | 3 | 0-5 | 1 |
| 1 | 2 | 0, 1, 2, 3, 12, 14 | 1 |
| 3 | 3 | 0, 1, 2, 3, 12, 14 | 1 |
| 4 | 3 | 0-5 | 2 |
| 5 | 3 | 0, 1, 2, 3, 6, 8 | 2 |
| 6 | 3 | 0, 1, 6, 7, 12, 13 | 2 |
| 7 | 3 | 2, 3, 8, 9, 14, 15 | 2 |
| 8 | 3 | 4, 5, 10, 11, 16, 17 | 2 |

In some embodiments, at least one of items 6 to 8 is not needed and not comprised in above table 37.

TABLE 38
Antenna port(s), transform precoder is disabled,
dmrs-Type = 2, maxLength = 1, rank = 7

| | Number of DMRS | | Number of |
|---|---|---|---|
| | CDM group(s) | | front-load |
| Value | without data | DMRS port(s) | symbols |
| 0 | 2 | 0, 1, 2, 3, 12, 13, 14 | 1 |
| 1 | 3 | 0, 1, 2, 3, 12, 13, 14 | 1 |
| 3 | 3 | 0, 1, 2, 3, 4, 5, 12 | 1 |
| 4 | 3 | 0, 1, 2, 3, 6, 7, 8 | 2 |
| 5 | 3 | 0, 1, 2, 3, 4, 5, 6 | 2 |
| 6 | 3 | 0, 1, 6, 7, 12, 13, 18 | 2 |
| 7 | 3 | 2, 3, 8, 9, 14, 15, 20 | 2 |
| 8 | 3 | 4, 5, 10, 11, 16, 17, 22 | 2 |

In some embodiments, at least one of items 6 to 8 is not needed and not comprised in above table 38.

TABLE 39
Antenna port(s), transform precoder is disabled,
dmrs-Type = 2, maxLength = 1, rank = 8

| | Number of DMRS | | Number of |
|---|---|---|---|
| | CDM group(s) | | front-load |
| Value | without data | DMRS port(s) | symbols |
| 0 | 2 | 0, 1, 2, 3, 12, 13, 14, 15 | 1 |
| 1 | 3 | 0, 1, 2, 3, 12, 13, 14, 15 | 1 |
| 3 | 3 | 0, 1, 2, 3, 4, 5, 12, 14 | 1 |
| 4 | 3 | 0, 1, 2, 3, 4, 5, 6, 8 | 2 |
| 5 | 3 | 0, 1, 2, 3, 6, 7, 8, 9 | 2 |
| 6 | 3 | 0, 1, 6, 7, 12, 13, 18, 19 | 2 |
| 7 | 3 | 2, 3, 8, 9, 14, 15, 20, 21 | 2 |
| 8 | 3 | 4, 5, 10, 11, 16, 17, 22, 23 | 2 |

In some embodiments, at least one of items 6 to 8 is not needed and not comprised in above table 39.

In this way, when indicating the DMRS configuration, the signalling overhead is reduced thereby.

### Example Processed for DMRS Configuration

According to some embodiments of the present discourse, the number of co-scheduled terminal device may be limited.

Specifically, in some embodiments, in case of a 2-symbol DMRS transmission, the maximum number of DMRS indications associated with a single layer transmission or a single DMRS port and associated with number of CDM groups without data being 2 or 3 may be less than a pre-defined number.

In some embodiments, in case of a first DMRS type, the pre-defined number is 16. In some embodiments, in case of a second DMRS type, the pre-defined number is 24.

In some embodiments, in case of a first DMRS type, the maximum number of DMRS indications is 8 or 12. In some embodiments, in case of a second DMRS type, the maximum number of DMRS indications is 12 or 16.

That is, in some embodiments, at least for 2-symbol DMRS (i.e., maxLength=2), there is no need to co-schedule 16 or 24 single-layer terminal device 220. As a result, the number of DMRS indications with single port is less than 16 for DMRS type 1 and/or less than 24 for DMRS type 2.

In some embodiments, in case of a first DMRS type, the maximum number of DMRS indications associated with the following may be less than or no larger than 8 or 12 or 16:
a single layer transmission or a single DMRS port
the number of CDM groups without data being 2, and
the number of front-loaded DMRS symbols being 2.

In some embodiments, in case of a first DMRS type, the maximum number of DMRS indications associated with the following may be less than or no larger than 4:
a single layer transmission or a single DMRS port,
the number of CDM groups without data being 2, and
the number of front-loaded DMRS symbols being 1 (For example, in case that the maximum number of front-loaded DMRS symbols is 2).

In some embodiments, in case of a second DMRS type, the maximum number of DMRS indications associated with the following may be less than or no larger than 12 or 16:
a single layer transmission or a single DMRS port,
the number of CDM groups without data being 3, and
the number of front-loaded DMRS symbols being 2 (For example, in case that the maximum number of front-loaded DMRS symbols is 2).

In some embodiments, in case of a second DMRS type, the maximum number of DMRS indications associated with the following may be less than or no larger than 6:
a single layer transmission or a single DMRS port,
the number of CDM groups without data being 3,
the number of front-loaded DMRS symbols is 1 (for example, in case that the maximum number of front-loaded DMRS symbols is 2).

In some embodiments, in case of a first DMRS type, the maximum number of DMRS indications associated with the following may be less than or no larger than 6 or 8:
a single layer transmission or a single DMRS port,
the number of CDM groups without data being 2, and
the number of front-loaded DMRS symbols being 1 (for example, in case that the maximum number of front-loaded DMRS symbols is 1).

In some embodiments, in case of a second DMRS type, the maximum number of DMRS indications associated with the following may be less than or no larger than 6 or 8 or 12:
a single layer transmission or a single DMRS port,
the number of CDM groups without data being 3,
the number of front-loaded DMRS symbols being 1 (for example, in case that the maximum number of front-loaded DMRS symbols is 1).

In one specific embodiment, as for DMRS with the second DMRS type, the total number of DMRS indications with single port (and with 2-symbol front-loaded DMRS and with number of CDM groups without data being 3) may be 12.

In another specific embodiment, as for DMRS with the first DMRS type, the total number of DMRS indications with single port (and with 2-symbol front-loaded DMRS and with number of CDM groups without data being 2) may be 8.

In this way, the complexity of co-schedule of the terminal device is controlled.

### Example Processed for DMRS Configuration

In some cases, the capability of terminal device for supporting the length of FD-OCC are different. For example, a first type of terminal device (such as, 3GPP release 15) co-scheduled with a second type of terminal device (such as, 3GPP release 18), where the first type of terminal device supports length-2 FD-OCC, while the second type of terminal device supports length-4/6 FD-OCC. In this event, the first type of terminal device maybe not aware of newly-introduced DMRS ports (i.e., the first port index set) for the second type of the terminal device, which may cause an unexpected interference.

According to some embodiments of the present discourse, the interference caused by the second type of the terminal device may be reduced by reducing DMRS to PDSCH and/or PUSCH power boosting.

Still refers to FIG. 4, in some embodiments, either the network device 210 or the terminal device 220 obtains 430/420 the number of CDM groups without data configured for a terminal device 220, where the terminal device enables to communicate with a network device via a FD-OCC with a first length (such as, 4 or 6).

Then, a DMRS communication is performed 430 between the network device 210 and the terminal device 220. In particular, the DMRS communication is performed via a first power ratio of a PDSCH to the DMRS, wherein the first power ratio is larger than a second power ratio, and the second power ratio is based on the number of CDM groups without data.

In some embodiments, in case of the number of CDM groups without data is 2, the second power ratio is −3 dB, and the first power ratio is 0 dB or −1 dB or −2 dB. Alternatively, in some other embodiments, in case of the number of CDM groups without data is 3, the second power ratio is −4.77 dB, and the first power ratio is 0 dB or −3 dB.

In some embodiments, the first power radio is indicated by one of the following: a RRC signalling, a MAC CE, or DCI.

In some embodiments, as for DMRS port(s) indications with CDM groups without data=2 (or 3) (i.e., DMRS port index being comprised in the first port index set), the power ratio between DMRS and PDSCH may be indicated/configured as 0 dB or −2 dB (or 0 dB or −3 dB).

In case of DCI indication, there may be some DMRS port(s) indications indicating same number of DMRS ports, same DMRS port indexes, same number of CDM groups without data, and different indications indicate different power ratio between DMRS and PDSCH.

In this way, the inter-UE interference is reduced, especially for the scenario where a first type of terminal device (such as, 3GPP release 15) co-scheduled with a second type of terminal device (such as, 3GPP release 18).

### Example Processed for FD-OCC Mapping

As a general rule, each RB usually comprises 12*7 REs. Further, DMRS type 1 is a comb-structure and the number of CDM groups is 2. In view of this, if length-4 FD-OCC is agreed for DMRS type 1, generally, two RBs are needed for full orthogonal.

In some embodiments, in order to ensure the performance, one length-4 FD-OCC should be mapped across two adjacent RBs.

Further, in order to reduce complexity for measuring/handling interference from co-scheduled terminal devices 120, the boundary of co-scheduled terminal devices 120 is expected to be aligned (such as, based on precoding resource block group (PRG) boundary or based on physical resource block (PRB) bundling boundary or based on common RB index). In some embodiments, the size of one PRG may be 2 RBs or 4 RBs or wideband.

In some embodiments, either the network device 120 or the terminal device 220 obtains a configuration for a DMRS transmission. Further, in case of a length of FD-OCC associated with the DMRS transmission is 4, performing an FD-OCC mapping on at least one RB based on a precoding group boundary, or a PRB bundling boundary (As shown in FIG. 5A, which illustrates an example of FD-OCC mapping 500).

Alternatively, or in addition, in case of a length of FD-OCC associated with the DMRS transmission is 4, performing an FD-OCC mapping on at least one RB based on a common RB index (As shown in FIG. 5B, which illustrates an example of FD-OCC mapping 550).

In some embodiments, if the length of FD-OCC is 4, the FD-OCC vectors mapping in frequency domain is based on the common RB index or based on the PRB bundling boundary.

In this way, it enables to make full use of orthogonality between DMRS ports, and increase scheduling flexibility (for example, no need of full-overlapping for MU UEs). Further, it enables to reduce UE complexity for measuring/handling interference from co-scheduled UEs. For example, if Walsh code is applied for FD-OCC, orthogonality is fine, which may only cause some “minor” complexity for UE measuring/handling interference.

Further, according to the above examples, even if number of allocated RBs for a terminal device 120 is even, there may still be “orphan” RB(s) for the terminal device 120.

In some embodiments, as for DMRS type 1, if the length of FD-OCC is 4, the FD-OCC vectors mapping in frequency domain is based on the common RB index or based on the PRB bundling boundary. Further, the FD-OCC mapping may be performed according to below Equation (1) and Equation (2).

If p∈{1000, 1001, 1002, 1003, 1004, 1005, 1006, 1007}

$${a}_{k , l}^{( p , μ )} = β {w}_{f} ( {k}^{′} ) {w}_{t} ( {l}^{′} ) r ( 2 n + {k}^{′} ) \qquad Equation ( 1 )$$

$$k = 4 n + 2 {k}^{′} + Δ$$

$${k}^{′} = 0 , 1$$

$$l = \overline{l} + {l}^{′}$$

$$n = 0 , 1 , …$$

Otherwise

$${a}_{k , l}^{( p , μ )} = β {w}_{f} ( {k}^{′′} ) {w}_{t} ( {l}^{′} ) r ( 2 n + {k}^{′} ) \qquad Equation ( 2 )$$

$$k = 4 n + 2 {k}^{′} + Δ$$

$${k}^{′′} = ( 2 n + {k}^{′} ) mod 4$$

$$l = \overline{l} + {l}^{′}$$

$$n = 0 , 1 , …$$

It is to be understood that the above Equation (1) and Equation (2) are only for the purpose of illustration without suggesting any limitations. In fact, the FD-OCC mapping manner discussed in the present discourse may be achieved by any suitable means. The present discourse is not limited in this regard.

### Example of Methods

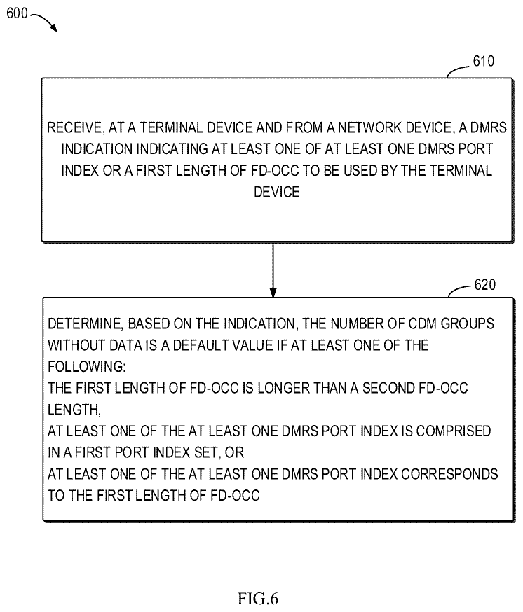

FIG. 6 illustrates a flowchart of an example method 600 in accordance with some embodiments of the present disclosure. For example, the method 600 can be implemented at the terminal device 220 as shown in FIG. 2.

At block 610, the terminal device 220 receives a DMRS indication from a network device, where the DMRS indication indicating at least one of at least one DMRS port index or a first length of FD-OCC to be used by the terminal device 220.

At block 620, the terminal device 220 determines based on the DMRS indication, the number of CDM groups without data is a default value if at least one of the following: the first length of FD-OCC is longer than a second FD-OCC length, at least one of the at least one DMRS port index is comprised in a first port index set, or at least one of the at least one DMRS port index corresponds to the first length of FD-OCC.

In some embodiments, in case of a first DMRS type, the default value is 2; and in case of a second DMRS type, the default value is 3.

In some embodiments, the second FD-OCC length is 2, and the first length of FD-OCC is 4 or 6.

In some embodiments, in case of a first DMRS type, the first port index set is one of {8, 9, 10, 11} or {8, 9, 10, 11, 12, 13, 14, 15}.

In some embodiments, in case of a second DMRS type, the first port index set is one of {12, 13, 14, 15, 16, 17} or {12, 13, 14, 15, 16, 17, 18, 19, 20, 21, 22, 23}.

In some embodiments, in case of a 2-symbol DMRS transmission, the maximum number of DMRS indications associated with a single layer transmission or a single DMRS port is less than a pre-defined number.

In some embodiments, in case of a first DMRS type, the pre-defined number is 16, and in case of a second DMRS type, the pre-defined number is 24.

In some embodiments, in case of a first DMRS type, the maximum number of DMRS indications is 8 or 12; and in case of a second DMRS type, the maximum number of DMRS indications is 12 or 16.

In some embodiments, the DMRS indication is comprised in DCI.

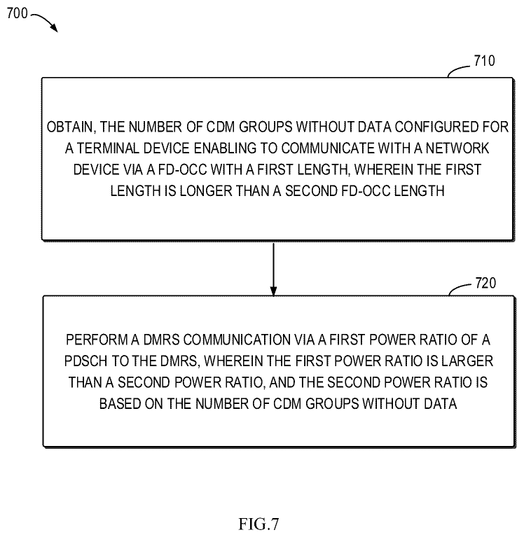

FIG. 7 illustrates a flowchart of an example method 700 in accordance with some embodiments of the present disclosure. For example, the method 700 can be implemented at the device (either a terminal device 120 or a network device 110 as shown in FIG. 2).

At block 710, the device obtains the number of CDM groups without data configured for a terminal device 220 enabling to communicate with a network device via a FD-OCC with a first length, wherein the first length is longer than a second FD-OCC length.

At block 720, the device performs a DMRS communication via a first power ratio of a PDSCH to the DMRS, wherein the first power ratio is larger than a second power ratio, and the second power ratio is based on the number of CDM groups without data.

In some embodiments, in case of the number of CDM groups without data is 2, the second power ratio is −3 dB, and the first power ratio is 0 dB or −1 dB or −2 dB; and in case of the number of CDM groups without data is 3, the second power ratio is −4.77 dB, and the first power ratio is 0 dB or −3 dB.

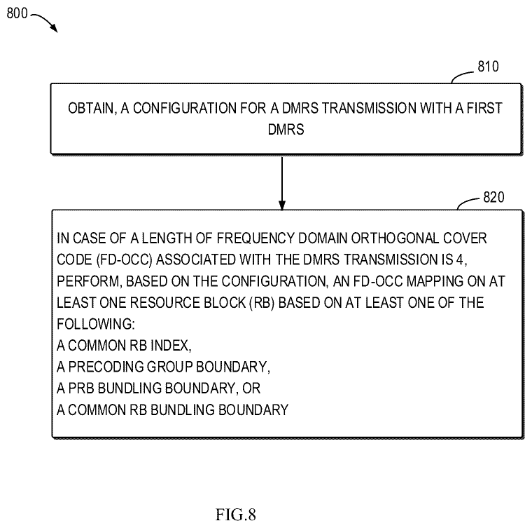

In some embodiments, the first power radio is indicated by one of the following: an RRC signalling, a MAC CE, or DCI. FIG. 8 illustrates a flowchart of an example method 800 in accordance with some embodiments of the present disclosure. For example, the method 800 can be implemented at the device (either a terminal device 120 or a network device 110 as shown in FIG. 2).

At block 810, the device obtains a configuration for a DMRS transmission; and

At block 820, the device in case of a length of FD-OCC associated with the DMRS transmission is 4, performs, based on the configuration, an FD-OCC mapping on at least one RB based on at least one of the following: a common RB index, a precoding group boundary, a PRB bundling boundary, or a common RB bundling boundary.

### Example of Apparatuses and Devices

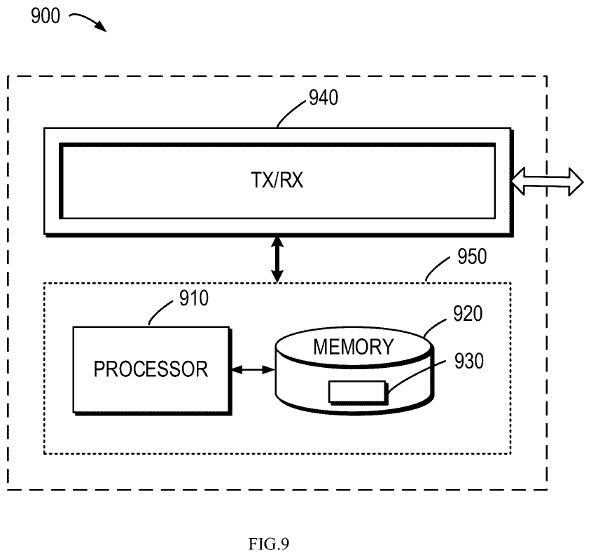

FIG. 9 is a simplified block diagram of a device 900 that is suitable for implementing embodiments of the present disclosure. The device 900 can be considered as a further example implementation of the terminal device 220 or a network device 210 as shown in FIG. 2. Accordingly, the device 900 can be implemented at or as at least a part of the terminal device 220 or the network device 210.

As shown, the device 900 includes a processor 910, a memory 920 coupled to the processor 910, a suitable transmitter (TX)/receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 2 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, the terminal device 220 comprises a circuitry configured to:
receive a DMRS indication from a network device, where the DMRS indication indicating at least one of at least one DMRS port index or a first length of FD-OCC to be used by the terminal device 220; and determine based on the DMRS indication, the number of CDM groups without data is a default value if at least one of the following: the first length of FD-OCC is longer than a second FD-OCC length, at least one of the at least one DMRS port index is comprised in a first port index set, or at least one of the at least one DMRS port index corresponds to the first length of FD-OCC.

In some embodiments, in case of a first DMRS type, the default value is 2; and in case of a second DMRS type, the default value is 3.

In some embodiments, the second FD-OCC length is 2, and the first length of FD-OCC is 4 or 6.

In some embodiments, in case of a first DMRS type, the first port index set is one of {8, 9, 10, 11} or {8, 9, 10, 11, 12, 13, 14, 15}.

In some embodiments, in case of a second DMRS type, the first port index set is one of {12, 13, 14, 15, 16, 17} or {12, 13, 14, 15, 16, 17, 18, 19, 20, 21, 22, 23}.

In some embodiments, in case of a 2-symbol DMRS transmission, the maximum number of DMRS indications associated with a single layer transmission or a single DMRS port is less than a pre-defined number.

In some embodiments, in case of a first DMRS type, the pre-defined number is 16, and in case of a second DMRS type, the pre-defined number is 24.

In some embodiments, in case of a first DMRS type, the maximum number of DMRS indications is 8 or 12; and in case of a second DMRS type, the maximum number of DMRS indications is 12 or 16.

In some embodiments, the DMRS indication is comprised in DCI.

In some embodiments, the device (either a terminal device 220 or a network device 110) comprises a circuitry configured to: obtain the number of CDM groups without data configured for a terminal device 220 enabling to communicate with a network device via a FD-OCC with a first length, wherein the first length is longer than a second FD-OCC length; and perform a DMRS communication via a first power ratio of a PDSCH to the DMRS, wherein the first power ratio is larger than a second power ratio, and the second power ratio is based on the number of CDM groups without data.

In some embodiments, in case of the number of CDM groups without data is 2, the second power ratio is −3 dB, and the first power ratio is 0 dB or −1 dB or −2 dB; and in case of the number of CDM groups without data is 3, the second power ratio is −4.77 dB, and the first power ratio is 0 dB or −3 dB.

In some embodiments, the first power radio is indicated by one of the following: an RRC signalling, a MAC CE, or DCI.

In some embodiments, the device (either a terminal device 220 or a network device 110) comprises a circuitry configured to: obtain a configuration for a DMRS transmission; and in case of a length of FD-OCC associated with the DMRS transmission is 4, perform, based on the configuration, an FD-OCC mapping on at least one RB based on at least one of the following: a common RB index, a precoding group boundary, a PRB bundling boundary, or a common RB bundling boundary.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: receiving, at a terminal device and from a network device, a demodulation reference signal (DMRS) indication indicating at least one of at least one DMRS port index or a first length of frequency domain orthogonal cover code (FD-OCC) to be used by the terminal device; and determining, based on the DMRS indication, the number of code domain multiplexing (CDM) groups without data is a default value if at least one of the following: the first length of FD-OCC is longer than a second FD-OCC length, at least one of the at least one DMRS port index is comprised in a first port index set, or at least one of the at least one DMRS port index corresponds to the first length of FD-OCC.

In some embodiments, in case of a first DMRS type, the default value is 2; and in case of a second DMRS type, the default value is 3.

In some embodiments, the second FD-OCC length is 2, and the first length of FD-OCC is 4 or 6.

In some embodiments, in case of a first DMRS type, the first port index set is one of {8, 9, 10, 11} or {8, 9, 10, 11, 12, 13, 14, 15}.

In some embodiments, in case of a second DMRS type, the first port index set is one of {12, 13, 14, 15, 16, 17} or {12, 13, 14, 15, 16, 17, 18, 19, 20, 21, 22, 23}.

In some embodiments, in case of a 2-symbol DMRS transmission, the maximum number of DMRS indications associated with a single layer transmission or a single DMRS port is less than a pre-defined number.

In some embodiments, in case of a first DMRS type, the pre-defined number is 16, and in case of a second DMRS type, the pre-defined number is 24.

In some embodiments, in case of a first DMRS type, the maximum number of DMRS indications is 8 or 12; and in case of a second DMRS type, the maximum number of DMRS indications is 12 or 16.

In some embodiments, the DMRS indication is comprised in downlink control information (DCI).

In one solution, a method of communication comprises: obtaining, the number of code domain multiplexing (CDM) groups without data configured for a terminal device enabling to communicate with a network device via a frequency domain orthogonal cover code (FD-OCC) with a first length, wherein the first length is longer than a second FD-OCC length; and performing a demodulation reference signal (DMRS) communication via a first power ratio of a physical downlink shared channel (PDSCH) to the DMRS, wherein the first power ratio is larger than a second power ratio, and the second power ratio is based on the number of CDM groups without data.

In some embodiments, in case of the number of CDM groups without data is 2, the second power ratio is −3 dB, and the first power ratio is 0 dB or −1 dB or −2 dB; and in case of the number of CDM groups without data is 3, the second power ratio is −4.77 dB, and the first power ratio is 0 dB or −3 dB.

In some embodiments, the first power radio is indicated by one of the following: a radio resource control (RRC) signalling, a medium access control (MAC) control element (CE), or downlink control information (DCI).

In one solution, a method of communication comprises: obtaining, a configuration for a demodulation reference signal (DMRS) transmission; and in case of a length of frequency domain orthogonal cover code (FD-OCC) associated with the DMRS transmission is 4, performing, based on the configuration, an FD-OCC mapping on at least one resource block (RB) based on at least one of the following: a common RB index, a precoding group boundary, a physical resource block (PRB) bundling boundary, or a common RB bundling boundary.

In another solution, a device of communication comprises: a processor configured to cause the device to perform any of the methods above.

In a further solution, a computer readable medium has instructions stored thereon, the instructions, when executed on at least one processor, causing the at least one processor to perform the method according to any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-16. (canceled)

17. A method of a User Equipment (UE), the method comprising:
receiving, from a network, Downlink Control Information (DCI) which includes information on one or more antenna ports,
wherein the information corresponds to a first value which indicates one or more Demodulation Reference Signal (DMRS) code division multiplexing (CDM) groups without data and a second value which indicates one or more DMRS ports, and
wherein the second value includes at least one of 12, 13, 14, 15, 16, 17, 18, 19, 20, 21, 22, and 23.

18. The method according to claim 17,
wherein one of the one or more DMRS ports has a frequency domain orthogonal cover code (FD-OCC) with length 4.

19. The method according to claim 17, further comprising:
determining the first value and the second value based on the information.

20. The method according to claim 17,
wherein the information corresponds to the first value, the second value, and a third value which indicates a number of front-load symbols.

21. The method according to claim 20, further comprising:
determining the first value, the second value, and the third value based on the information.

22. The method according to claim 17, further comprising:
receiving, from the network, a Physical Downlink Shared Channel (PDSCH) based on the DCI; and
assuming that a number of physical resource blocks for the PDSCH is even and an offset of each of the physical resource blocks for the PDSCH from a common resource block is an even number.

23. The method according to claim 17,
wherein the DCI is DCI format 0_1.

24. A method of a network device, the method comprising:
sending, to a User Equipment (UE), Downlink Control Information (DCI) which includes information on one or more antenna ports,
wherein the information corresponds to a first value which indicates one or more Demodulation Reference Signal (DMRS) code division multiplexing (CDM) groups without data and a second value which indicates one or more DMRS ports, and
wherein the second value includes at least one of 12, 13, 14, 15, 16, 17, 18, 19, 20, 21, 22, and 23.

25. A User Equipment (UE) comprising:
a memory; and
a processor coupled with the memory, wherein the processor is configured to:
receive, from a network, Downlink Control Information (DCI) which includes information on one or more antenna ports,
wherein the information corresponds to a first value which indicates one or more Demodulation Reference Signal (DMRS) code division multiplexing (CDM) groups without data and a second value which indicates one or more DMRS ports, and
wherein the second value includes at least one of 12, 13, 14, 15, 16, 17, 18, 19, 20, 21, 22, and 23.

26. A network device comprising:
a memory; and
a processor coupled with the memory, wherein the processor is configured to:
send, to a User Equipment (UE), Downlink Control Information (DCI) which includes information on one or more antenna ports,
wherein the information corresponds to a first value which indicates one or more Demodulation Reference Signal (DMRS) code division multiplexing (CDM) groups without data and a second value which indicates one or more DMRS ports, and
wherein the second value includes at least one of 12, 13, 14, 15, 16, 17, 18, 19, 20, 21, 22, and 23.
